(19) United States
(12) Patent Application Publication
(10) Pub. No.: US 2026/0242132 A1
(43) Pub. Date: Aug. 20, 2026

(54) REFUSE VEHICLE WITH SYNCHRONIZED HOPPER PANEL AND PACK PANEL

(71) Applicant: Oshkosh Corporation, Oshkosh, WI (US)

(72) Inventors: Zhenyi Wei, Oshkosh, WI (US); Jeffrey Meyer, Oshkosh, WI (US); Vince Schad, Oshkosh, WI (US); Andy Cox, Oshkosh, WI (US); Brian Brost, Oshkosh, WI (US)

(73) Assignee: Oshkosh Corporation, Oshkosh, WI (US)

(21) Appl. No.: 19/541,072

(22) Filed: Feb. 16, 2026

Related U.S. Application Data
(60) Provisional application No. 63/759,481, filed on Feb. 17, 2025.
(60) Provisional application No. 63/951,996, filed on Dec. 31, 2025.

(51) Int. Cl. B65F 3/20; B65F 3/02; B65F 3/14

(52) U.S. Cl. CPC B65F 3/201; B65F 3/02; B65F 2003/0283; B65F 2003/146

(57) ABSTRACT

A refuse vehicle system includes one or more processing circuits configured to receive an input signal and control, in response to receiving the input signal, a first actuator coupled with a hopper panel of a refuse vehicle, and a second actuator coupled with a pack panel to synchronously move the hopper panel and the pack panel according to a packing procedure. Synchronous movement of the hopper panel and the pack panel facilitates compacting refuse in a refuse compartment of the refuse vehicle. The one or more processing circuits are configured to control the first actuator and the second actuator in a first mode of operation or a second mode of operation based on a refuse characteristic associated with the refuse.

### CROSS-REFERENCE TO RELATED PATENT APPLICATIONS

This application claims the benefit of and priority to U.S. Provisional Application No. 63/759,481, filed on Feb. 17, 2025, and U.S. Provisional Application No. 63/951,996, filed on Dec. 31, 2025, the entire disclosures of which are hereby incorporated by reference herein.

### BACKGROUND

The present disclosure relates generally to refuse vehicles. More specifically, the present disclosure relates to a packing system for a refuse vehicle.

### SUMMARY

One embodiment relates to a refuse vehicle system including one or more processing circuits. The one or more processing circuits are configured to receive an input signal. The one or more processing circuits are further configured to control, in response to receiving the input signal, a first actuator coupled with a hopper panel of a refuse vehicle, and a second actuator coupled with a pack panel to synchronously move the hopper panel and the pack panel according to a packing procedure. In some aspects, synchronous movement of the hopper panel and the pack panel facilitates compacting refuse in a refuse compartment of the refuse vehicle. In some aspects, the one or more processing circuits are configured to control the first actuator and the second actuator in a first mode of operation or a second mode of operation based on a refuse characteristic associated with the refuse.

Another embodiment relates to a refuse vehicle including a chassis, a refuse compartment supported by the chassis and including a hopper volume and a storage volume, a holding plate partially separating the hopper volume from the storage volume, a packing assembly, and one or more processing circuits. The packing assembly includes a hopper panel pivotably coupled with the holding plate, a first actuator coupled with the hopper panel, a pack panel, and a second actuator coupled with the pack panel. The one or more processing circuits are configured to receive an input signal to initiate a packing procedure, control, in response to receiving the input signal, the first actuator and the second actuator to synchronously move the hopper panel and the pack panel to compact refuse in the refuse compartment, and control the first actuator and the second actuator in a first mode of operation or a second mode of operation based on a refuse characteristic associated with the refuse.

Still another embodiment relates to a refuse vehicle system including a non-transitory computer-readable medium having instructions stored thereon that, when executed by one or more processors, cause the one or more processors to receive an input signal indicative of an initiation of a packing procedure for a refuse compartment of a refuse vehicle, determine, based on sensor data, a refuse characteristic associated with the refuse disposed within the refuse compartment, select a first mode of operation or a second mode of operation based on the refuse characteristic, and control a first actuator coupled with a hopper panel of the refuse vehicle and a second actuator coupled with a pack panel of the refuse vehicle to synchronously move the hopper panel and the pack panel according to the packing procedure that includes a plurality of steps, each step including a corresponding position of the hopper panel and a corresponding position of the pack panel. In some aspects, synchronous movement of the hopper panel and the pack panel according to the packing procedure facilitates compacting the refuse within the refuse compartment. In some aspects, the first mode of operation and the second mode of operation correspond to at least one of different sequences of the plurality of steps or different compaction forces applied by at least one of the hopper panel or the pack panel.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The present disclosure will become more fully understood from the following detailed description, taken in conjunction with the accompanying figures, wherein like reference numerals refer to like elements, in which:

FIG. 1 is a left side view of a vehicle, according to an exemplary embodiment.

FIG. 2 is a perspective view of a chassis of the vehicle of FIG. 1.

FIG. 3 is a perspective view of the vehicle of FIG. 1 configured as a front-loading refuse vehicle, according to an exemplary embodiment.

FIG. 4 is a left side view of the front-loading refuse vehicle of FIG. 3 configured with a tag axle.

FIG. 5 is a perspective view of the vehicle of FIG. 1 configured as a side-loading refuse vehicle, according to an exemplary embodiment.

FIG. 6 is a right side view of the side-loading refuse vehicle of FIG. 5.

FIG. 7 is a top view of the side-loading refuse vehicle of FIG. 5.

FIG. 8 is a left side view of the side-loading refuse vehicle of FIG. 5 configured with a tag axle.

FIG. 9 is a perspective view of the side-loading refuse vehicle of FIG. 5 including a hopper panel, according to an exemplary embodiment.

FIG. 10 is a perspective view of the side-loading refuse vehicle of FIG. 5 including the hopper panel of FIG. 9, according to an exemplary embodiment.

FIG. 11 is a perspective view of the side-loading refuse vehicle of FIG. 5 with the hopper panel of FIG. 9 removed, according to an exemplary embodiment.

FIG. 12 is a cross-sectional view of a refuse compartment and a packing assembly of the side-loading vehicle of FIG. 5, with a pack panel in a retracted position, according to an exemplary embodiment.

FIG. 13 is a cross-sectional view of a refuse compartment and a packing assembly of the side-loading vehicle of FIG. 5, with a pack panel extended between a retracted position and an extended position, according to an exemplary embodiment.

FIG. 14 is a block diagram of a controller of the side-loading refuse vehicle of FIG. 5, according to an exemplary embodiment.

FIG. 15 is a method of controlling a refuse vehicle, according to an exemplary embodiment.

FIG. 16 is another method of controlling a refuse vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle (e.g., a refuse vehicle) includes a packing input (e.g., a button, a switch, a joystick, a soft key on a display, etc.) that, when activated, automatically initiates a packing procedure. The packing procedure includes moving a hopper panel toward a hopper volume of a refuse compartment of the vehicle and extending a pack panel of a packing assembly back and forth between a retracted position and a plurality of extended positions within the refuse compartment of the vehicle. In response to the packing input, a control system is configured to initiate the packing procedure to (i) move the hopper panel toward the hopper volume and (ii) extend the pack panel toward an extended position. The positions of the hopper panel and the pack panel moved to during the packing procedure are predefined and activation of the packing input removes the need for a user of the refuse vehicle to manually control the movement of the hopper panel and the pack panel during the packing procedure. The control system is configured to instruct a hopper panel actuator and a pack panel actuator to synchronously (e.g., cooperatively, coordinately, etc.) execute the predefined packing procedure. By way of example, in response to the packing input (e.g., a single user input), the control system may control the hopper panel actuator and the pack panel actuator to synchronously move (e.g., move at the same time, move to the one or more predefined positions, or otherwise coordinate movement, etc.) the hopper panel and the pack panel, respectively. In this way, for example, the packing procedure is automatically controlled and initiated by activation of the packing input, which removes the need for a user of the refuse vehicle to manually control the packing procedure (e.g., manually control the hopper panel actuator and the pack panel actuator independent of each other). Further, automatically initiating the packing procedure enables better (e.g., more accurate, efficient, etc.) control of the positions of the hopper panel and the pack panel to help prevent or inhibit refuse from unintentionally leaving the refuse compartment and falling behind the pack panel, to help prevent or inhibit damage to the packing assembly, the hopper panel, the hopper panel actuator, etc.

According to another embodiment, the refuse vehicle includes at least one sensor (e.g., a camera, infrared sensor, ultraviolet sensor, scale, or other refuse sensor). The sensor is configured to detect at least one characteristic (e.g., height, weight, volume, density, or other characteristics) of refuse disposed within the refuse vehicle. The refuse vehicle is configured to automatically actuate the pack panel and/or the hopper panel when the characteristic satisfies a threshold value. For example, the pack panel may automatically actuate when the volume of the refuse disposed within the refuse vehicle (e.g., within the hopper) rises above a particular volume (e.g., about 30 cubic yards), to compact the refuse (e.g., into the storage volume). By way of another example, the hopper panel may automatically actuate when a height of refuse within the refuse vehicle rises above a particular height (e.g., about three feet), compacting the refuse disposed within the refuse vehicle.

In some embodiments, the sensor and/or another sensor are further configured to detect refuse that falls behind the pack panel onto or near the pack panel actuator (e.g., into an area on the same side of the pack panel as the pack panel actuator). The system may notify (e.g., alert) the operator responsive to sensor data from the sensor that indicates material near the pack panel actuator (e.g., to inform the operator that the area behind the pack panel needs to be cleaned out). Such arrangements can greatly reduce or eliminate the need for an operator to look at a camera monitor to continuously assess the condition in the hopper area (e.g., to see if refuse material is packing properly, and/or if the refuse material is bridging the hopper or passing above the pack panel, etc.), which can improve safety and improve efficiency (e.g., by preventing the operator from spending time monitoring the hopper monitor in a stopped vehicle condition, or from looking at the hopper monitor while driving). Such arrangements can also eliminate the need to periodically check and manually clean out the area of the pack actuator, which can reduce labor costs and improve productivity.

In some embodiments, the system also includes a camera oriented toward the hopper. The system may be configured to capture images of the hopper and/or pack panel actuator to record the condition based on the sensor data. The system may be configured to present such images to a customer (e.g., a fleet management service) to notify them of the operating condition along with a time/date that the images were taken. Such an approach can help to prevent false warranty claims associated with lack of vehicle maintenance/cleaning, which can lead to premature pack panel actuator failure. In some embodiments, a movement speed or direction of the pack panel is changed when refuse is detected in the pack panel actuator, to reduce the risk of damage to the pack panel actuator and/or other vehicle components.

### Overall Vehicle

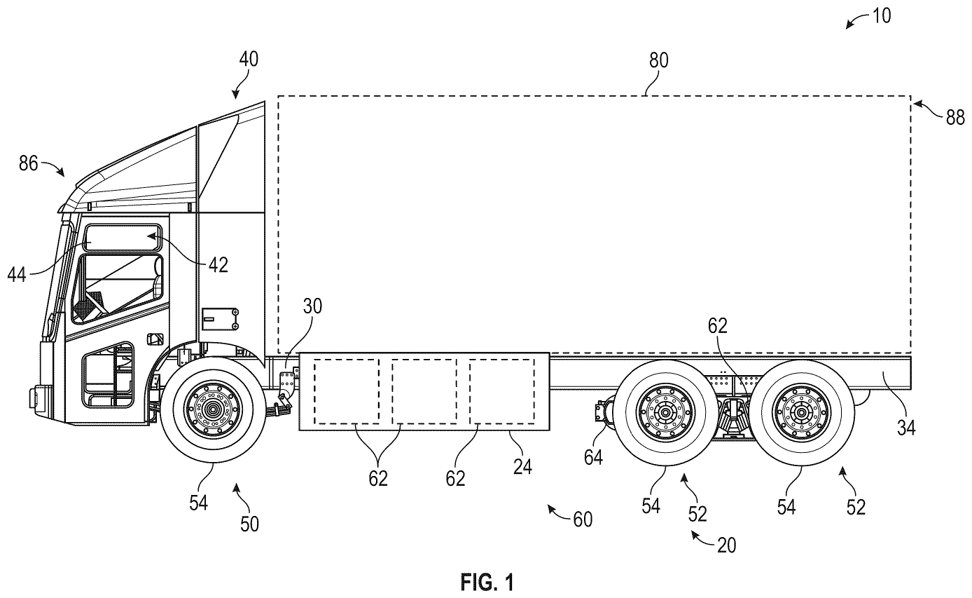

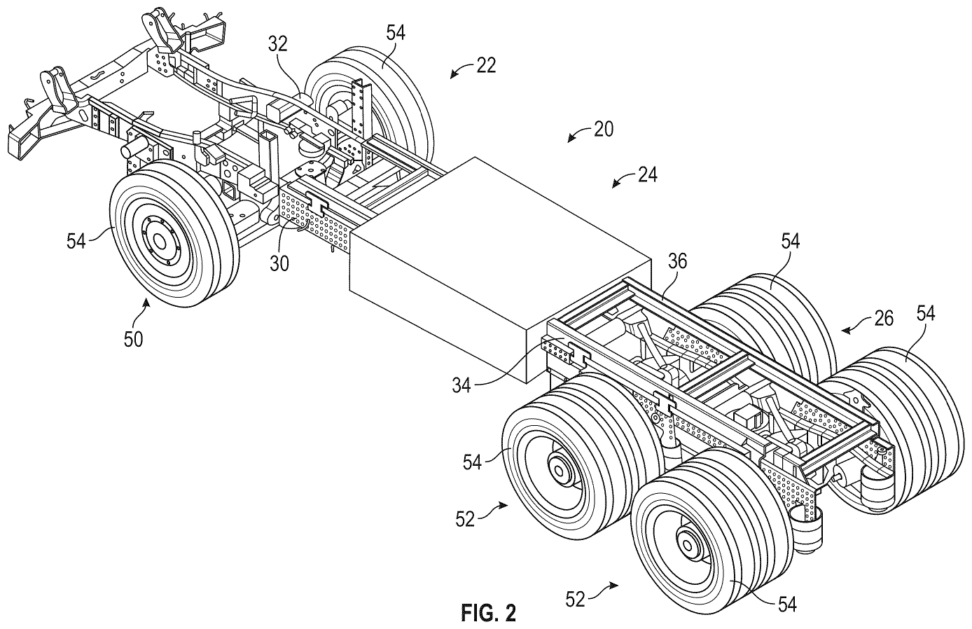

Referring to FIGS. 1 and 2, a reconfigurable vehicle (e.g., a vehicle assembly, a truck, a vehicle base, etc.) is shown as vehicle 10, according to an exemplary embodiment. As shown, the vehicle 10 includes a frame assembly or chassis assembly, shown as chassis 20, that supports other components of the vehicle 10. The chassis 20 extends longitudinally along a length of the vehicle 10, substantially parallel to a primary direction of travel of the vehicle 10. As shown, the chassis 20 includes three sections or portions, shown as front section 22, middle section 24, and rear section 26. The middle section 24 of the chassis 20 extends between the front section 22 and the rear section 26. In some embodiments, the middle section 24 of the chassis 20 couples the front section 22 to the rear section 26. In other embodiments, the front section 22 is coupled to the rear section 26 by another component (e.g., the body of the vehicle 10).

As shown in FIG. 2, the front section 22 includes a pair of frame portions, frame members, or frame rails, shown as front rail portion 30 and front rail portion 32. The rear section 26 includes a pair of frame portions, frame members, or frame rails, shown as rear rail portion 34 and rear rail portion 36. The front rail portion 30 is laterally offset from the front rail portion 32. Similarly, the rear rail portion 34 is laterally offset from the rear rail portion 36. This spacing may provide frame stiffness and space for vehicle components (e.g., batteries, motors, axles, gears, etc.) between the frame rails. In some embodiments, the front rail portions 30 and 32 and the rear rail portions 34 and 36 extend longitudinally and substantially parallel to one another. The chassis 20 may include additional structural elements (e.g., cross members that extend between and couple the frame rails).

In some embodiments, the front section 22 and the rear section 26 are configured as separate, discrete subframes (e.g., a front subframe and a rear subframe). In such embodiments, the front rail portion 30, the front rail portion 32, the rear rail portion 34, and the rear rail portion 36 are separate, discrete frame rails that are spaced apart from one another. In some embodiments, the front section 22 and the rear section 26 are each directly coupled to the middle section 24 such that the middle section 24 couples the front section 22 to the rear section 26. Accordingly, the middle section 24 may include a structural housing or frame. In other embodiments, the front section 22, the middle section 24, and the rear section 26 are coupled to one another by another component, such as a body of the vehicle 10.

In other embodiments, the front section 22, the middle section 24, and the rear section 26 are defined by a pair of frame rails that extend continuously along the entire length of the vehicle 10. In such an embodiment, the front rail portion 30 and the rear rail portion 34 would be front and rear portions of a first frame rail, and the front rail portion 32 and the rear rail portion 36 would be front and rear portions of a second frame rail. In such embodiments, the middle section 24 would include a center portion of each frame rail.

In some embodiments, the middle section 24 acts as a storage portion that includes one or more vehicle components. The middle section 24 may include an enclosure that contains one or more vehicle components and/or a frame that supports one or more vehicle components. By way of example, the middle section 24 may contain or include one or more electrical energy storage devices (e.g., batteries, capacitors, etc.). By way of another example, the middle section 24 may include fuel tanks. By way of yet another example, the middle section 24 may define a void space or storage volume that can be filled by a user.

A cabin, operator compartment, or body component, shown as cab 40, is coupled to a front end portion of the chassis 20 (e.g., the front section 22 of the chassis 20). Together, the chassis 20 and the cab 40 define a front end of the vehicle 10. The cab 40 extends above the chassis 20. The cab 40 includes an enclosure or main body that defines an interior volume, shown as cab interior 42, that is sized to contain one or more operators. The cab 40 also includes one or more doors 44 that facilitate selective access to the cab interior 42 from outside of the vehicle 10. The cab interior 42 contains one or more components that facilitate operation of the vehicle 10 by the operator. By way of example, the cab interior 42 may contain components that facilitate operator comfort (e.g., seats, seatbelts, etc.), user interface components that receive inputs from the operators (e.g., the operator controls 250, steering wheels, pedals, touch screens, switches, buttons, levers, etc.), and/or user interface components that provide information to the operators (e.g., lights, gauges, speakers, etc.). The user interface components within the cab 40 may facilitate operator control over the drive components of the vehicle 10 and/or over any implements of the vehicle 10.

The vehicle 10 further includes a series of axle assemblies, shown as front axle 50 and rear axles 52. As shown, the vehicle 10 includes one front axle 50 coupled to the front section 22 of the chassis 20 and two rear axles 52 each coupled to the rear section 26 of the chassis 20. In other embodiments, the vehicle 10 includes more or fewer axles. By way of example, the vehicle 10 may include a tag axle that may be raised or lowered to accommodate variations in weight being carried by the vehicle 10. The front axle 50 and the rear axles 52 each include a series of tractive elements (e.g., wheels, treads, etc.), shown as wheel and tire assemblies 54. The wheel and tire assemblies 54 are configured to engage a support surface (e.g., roads, the ground, etc.) to support and propel the vehicle 10. The front axle 50 and the rear axles may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle.

According to an exemplary embodiment, the vehicle 10 includes a drivetrain, shown as driveline 60, coupled to the chassis 20 and configured to propel the vehicle 10. In some embodiments, the vehicle 10 is configured as an electric vehicle that is propelled by an electric powertrain system. Referring to FIG. 1, the driveline 60 includes one or more electrical energy storage devices (e.g., batteries, capacitors, etc.), shown as batteries 62. As shown, the batteries 62 are positioned within the middle section 24 of the chassis 20. In other embodiments, the batteries 62 are otherwise positioned throughout the vehicle 10. The driveline 60 further includes one or more electromagnetic devices or prime movers (e.g., motor/generators), shown as drive motors 64. The drive motors 64 are electrically coupled to the batteries 62. The drive motors 64 may be configured to receive electrical energy from the batteries 62 and provide rotational mechanical energy to the wheel and tire assemblies 54 to propel the vehicle 10. The drive motors 64 may be configured to receive rotational mechanical energy from the wheel and tire assemblies 54 and provide electrical energy to the batteries 62, providing a braking force to slow the vehicle 10.

The batteries 62 may include one or more rechargeable batteries (e.g., lithium-ion batteries, nickel-metal hydride batteries, lithium-ion polymer batteries, lead-acid batteries, nickel-cadmium batteries, etc.). The batteries 62 may be charged by one or more sources of electrical energy onboard the vehicle 10 (e.g., solar panels, etc.) or separate from the vehicle 10 (e.g., connections to an electrical power grid, a wireless charging system, etc.). As shown, the drive motors 64 are positioned within the rear axles 52 (e.g., as part of a combined axle and motor assembly). In other embodiments, the drive motors 64 are otherwise positioned within the vehicle 10.

In other embodiments, the vehicle 10 is configured as a hybrid vehicle that is propelled by a hybrid powertrain system (e.g., a diesel/electric hybrid, gasoline/electric hybrid, natural gas/electric hybrid, etc.). According to an exemplary embodiment, the driveline 60 may include a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, etc.) to provide mechanical energy, which a transmission may receive and provide to the axle front axle 50 and/or the rear axles 52 to propel the vehicle 10. Additionally, or alternatively, the primary driver may provide mechanical energy to the generator, which converts the mechanical energy into electrical energy. The electrical energy may be stored in the energy storage device (e.g., the batteries 62) in order to later be provided to a motive driver.

In yet other embodiments, the chassis 20 may further be configured to support non-hybrid powertrains. For example, the driveline 60 may include a primary driver that is a compression-ignition internal combustion engine that utilizes diesel fuel.

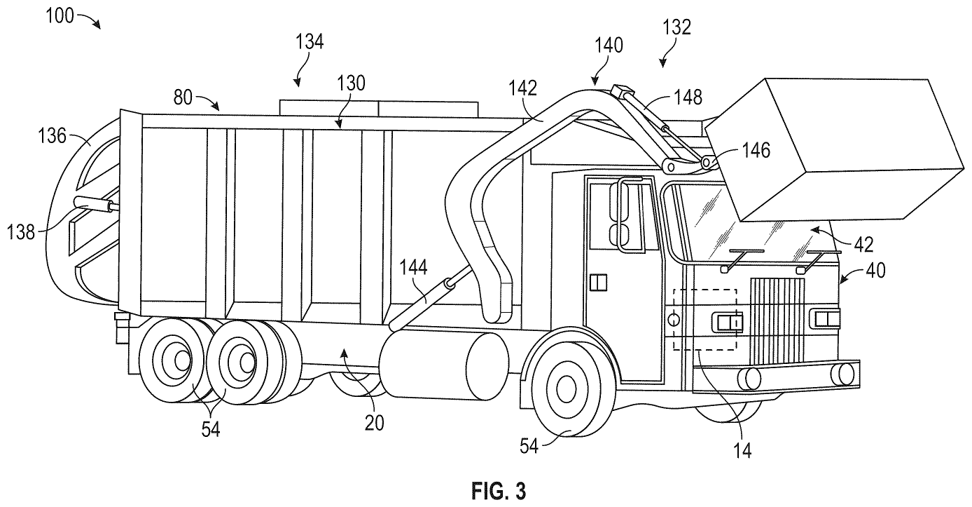

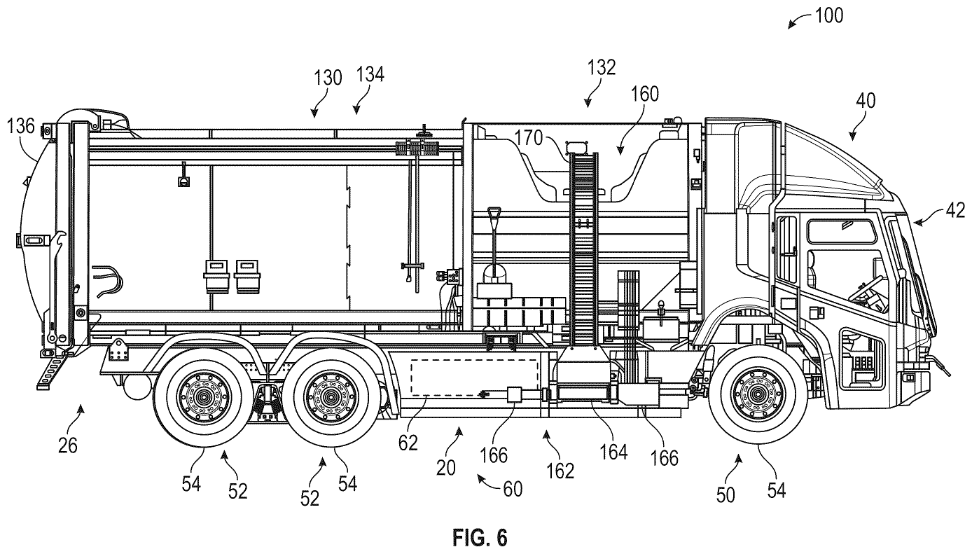

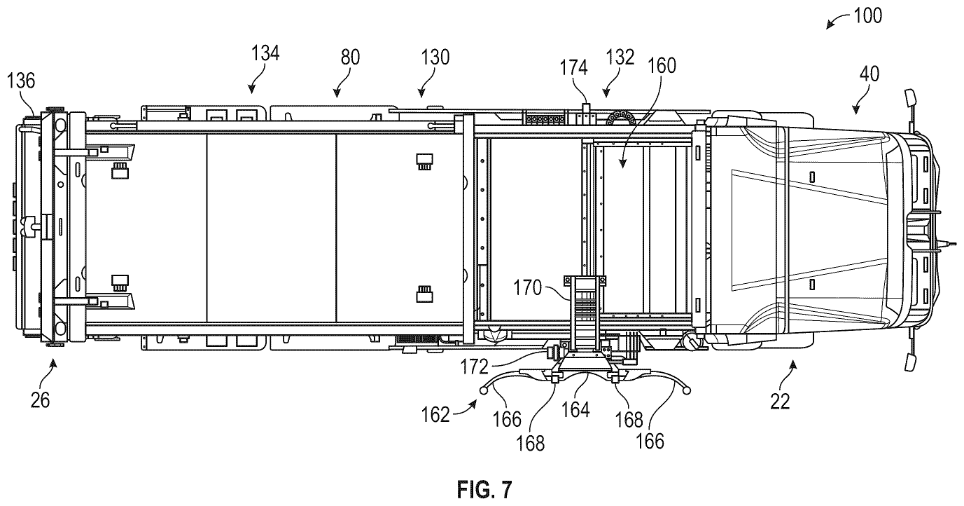

Referring to FIG. 1, the vehicle 10 includes a rear assembly, module, implement, body, or cargo area, shown as application kit 80. The application kit 80 may include one or more implements, vehicle bodies, and/or other components. Although the application kit 80 is shown positioned behind the cab 40, in other embodiments the application kit 80 extends forward of the cab 40. The vehicle 10 may be outfitted with a variety of different application kits 80 to configure the vehicle 10 for use in different applications. Accordingly, a common vehicle 10 can be configured for a variety of different uses simply by selecting an appropriate application kit 80. By way of example, the vehicle 10 may be configured as a refuse vehicle, a concrete mixer, a fire fighting vehicle, an airport fire fighting vehicle, a lift device (e.g., a boom lift, a scissor lift, a telehandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle. FIGS. 3-8 illustrate various examples of how the vehicle 10 may be configured for specific applications. Although only a certain set of vehicle configurations is shown, it should be understood that the vehicle 10 may be configured for use in other applications that are not shown.

The application kit 80 may include various actuators to facilitate certain functions of the vehicle 10. By way of example, the application kit 80 may include hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The application kit 80 may include components that facilitate operation of and/or control of these actuators. By way of example, the application kit 80 may include hydraulic or pneumatic components that form a hydraulic or pneumatic circuit (e.g., conduits, valves, pumps, compressors, gauges, reservoirs, accumulators, etc.). By way of another example, the application kit 80 may include electrical components (e.g., batteries, capacitors, voltage regulators, motor controllers, etc.). The actuators may be powered by components of the vehicle 10. By way of example, the actuators may be powered by the batteries 62, the drive motors 64, or the primary driver (e.g., through a power take off).

The vehicle 10 generally extends longitudinally from a front side 86 to a rear side 88. The front side 86 is defined by the cab 40 and/or the chassis 20. The rear side 88 is defined by the application kit 80 and/or the chassis 20. The primary, forward direction of travel of the vehicle 10 is longitudinal, with the front side 86 being arranged forward of the rear side 88.

### A. Front-Loading Refuse Vehicle

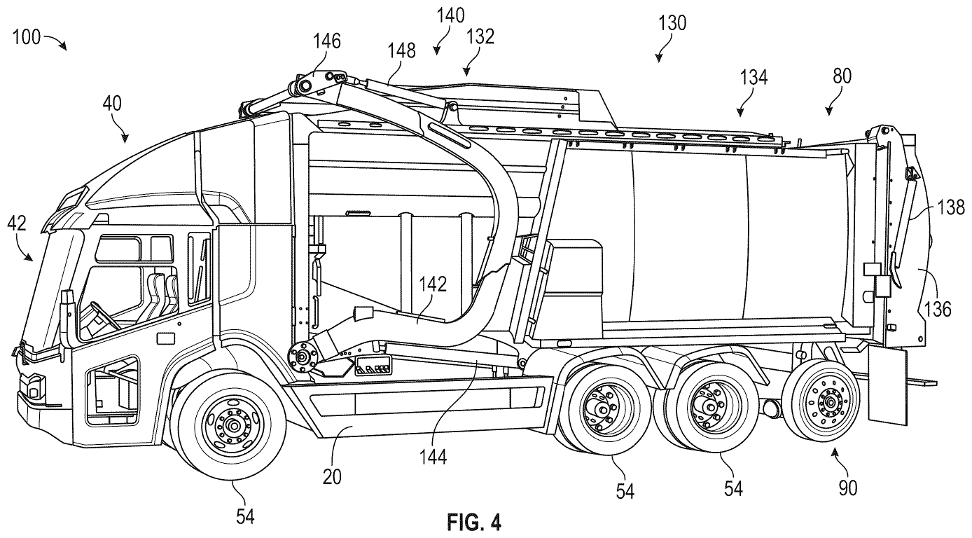

Referring now to FIGS. 3 and 4, the vehicle 10 is configured as a refuse vehicle 100 (e.g., a refuse truck, a garbage truck, a waste collection truck, a sanitation truck, a recycling truck, etc.). Specifically, the refuse vehicle 100 is a front-loading refuse vehicle. In other embodiments, the refuse vehicle 100 is configured as a rear-loading refuse vehicle or a side-loading refuse vehicle. The refuse vehicle 100 may be configured to transport refuse from various waste receptacles (e.g., refuse containers) within a municipality to a storage and/or processing facility (e.g., a landfill, an incineration facility, a recycling facility, etc.).

FIG. 4 illustrates the refuse vehicle 100 of FIG. 3 configured with a liftable axle, shown as tag axle 90, including a pair of wheel and tire assemblies 54. As shown, the tag axle 90 is positioned reward of the rear axles 52. The tag axle 90 can be selectively raised and lowered (e.g., by a hydraulic actuator) to selectively engage the wheel and tire assemblies 54 of the tag axle 90 with the ground. The tag axle 90 may be raised to reduce rolling resistance experienced by the refuse vehicle 100. The tag axle 90 may be lowered to distribute the loaded weight of the refuse vehicle 100 across a greater number of wheel and tire assemblies 54 (e.g., when the refuse vehicle 100 is loaded with refuse).

As shown in FIGS. 3 and 4, the application kit 80 of the refuse vehicle 100 includes a series of panels that form a rear body or container, shown as refuse compartment 130. The refuse compartment 130 may facilitate transporting refuse from various waste receptacles within a municipality to a storage and/or a processing facility (e.g., a landfill, an incineration facility, a recycling facility, etc.). By way of example, loose refuse may be placed into the refuse compartment 130 where it may be compacted (e.g., by a packer system within the refuse compartment 130). The refuse compartment 130 may also provide temporary storage for refuse during transport to a waste disposal site and/or a recycling facility. As shown in FIGS. 3 and 4, the refuse compartment 130 defines a hopper volume 132 and storage volume 134. In this regard, refuse may be initially loaded into the hopper volume 132 and later compacted into the storage volume 134. As shown, the hopper volume 132 is positioned between the storage volume 134 and the cab 40 (e.g., refuse is loaded into a portion of the refuse compartment 130 behind the cab 40 and stored in a portion further toward the rear of the refuse compartment 130). In other embodiments, the storage volume 134 is positioned between the hopper volume 132 and the cab 40 (e.g., in a rear-loading refuse truck, etc.). The application kit 80 of the refuse vehicle 100 further includes a pivotable rear portion, shown as tailgate 136, that is pivotally coupled to the refuse compartment 130. The tailgate 136 may be selectively repositionable between a closed position and an open position by an actuator (e.g., a hydraulic cylinder, an electric linear actuator, etc.), shown as tailgate actuator 138 (e.g., to facilitate emptying the storage volume).

As shown in FIGS. 3 and 4, the refuse vehicle 100 also includes an implement, shown as lift assembly 140, which is a front-loading lift assembly. According to an exemplary embodiment, the lift assembly 140 includes a pair of lift arms 142 and a pair of actuators (e.g., hydraulic cylinders, electric linear actuators, etc.), shown as lift arm actuators 144. The lift arms 142 may be rotatably coupled to the chassis 20 and/or the refuse compartment 130 on each side of the refuse vehicle 100 (e.g., through a pivot, a lug, a shaft, etc.), such that the lift assembly 140 may extend forward relative to the cab 40 (e.g., a front-loading refuse truck, etc.). In other embodiments, the lift assembly 140 may extend rearward relative to the application kit 80 (e.g., a rear-loading refuse truck). As shown in FIGS. 3 and 4, in an exemplary embodiment, the lift arm actuators 144 are such that extension and retraction of the lift arm actuators 144 rotates the lift arms 142 about an axis extending through the pivot. In this regard, the lift arms 142 may be rotated by the lift arm actuators 144 to lift a refuse container over the cab 40. The lift assembly 140 further includes a pair of interface members, shown as lift forks 146, each pivotally coupled to a distal end of one of the lift arms 142. The lift forks 146 may be configured to engage a refuse container (e.g., a dumpster) to selectively couple the refuse container to the lift arms 142. By way of example, each of the lift forks 146 may be received within a corresponding pocket defined by the refuse container. A pair of actuators (e.g., hydraulic cylinders, electric linear actuators, etc.), shown as articulation actuators 148, are each coupled to one of the lift arms 142 and one of the lift forks 146. The articulation actuators 148 may be positioned to rotate the lift forks 146 relative to the lift arms 142 about a horizontal axis. Accordingly, the articulation actuators 148 may assist in tipping refuse out of the refuse container and into the refuse compartment 130. The lift arm actuators 144 may then rotate the lift arms 142 to return the empty refuse container to the ground.

### B. Side-Loading Refuse Vehicle

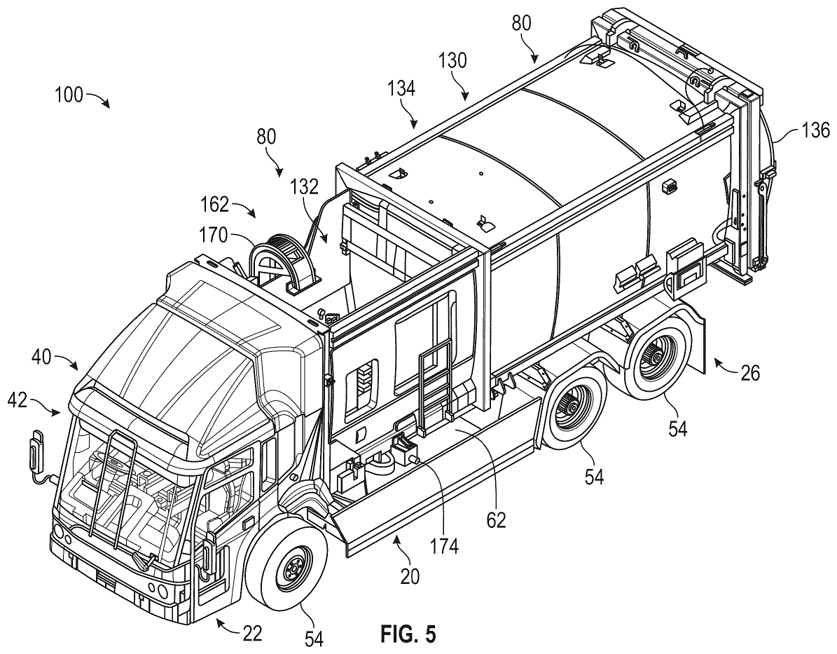

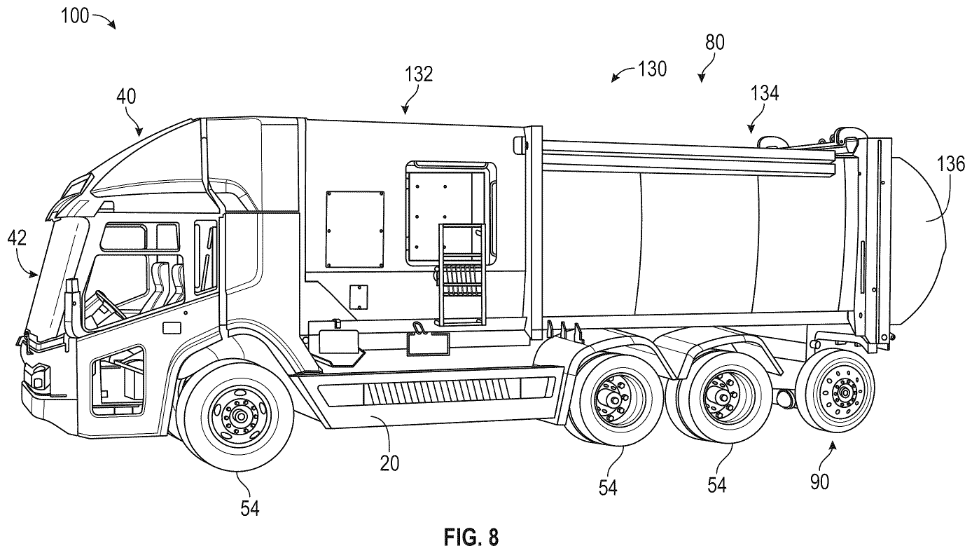

Referring now to FIGS. 5-8, an alternative configuration of the refuse vehicle 100 is shown according to an exemplary embodiment. Specifically, the refuse vehicle 100 of FIGS. 5-8 is configured as a side-loading refuse vehicle. The refuse vehicle 100 of FIGS. 5-8 may be substantially similar to the front-loading refuse vehicle 100 of FIGS. 3 and 4 except as otherwise specified herein. As shown, the refuse vehicle 100 of FIGS. 5-7 is configured with a tag axle 90 in FIG. 8.

Referring still to FIGS. 5-8, the refuse vehicle 100 omits the lift assembly 140 and instead includes a side-loading lift assembly, shown as lift assembly 160, that extends laterally outward from a side of the refuse vehicle 100. The lift assembly 160 includes an interface assembly, shown as grabber assembly 162, that is configured to engage a refuse container (e.g., a residential garbage can) to selectively couple the refuse container to the lift assembly 160. The grabber assembly 162 includes a main portion, shown as main body 164, and a pair of fingers or interface members, shown as grabber fingers 166. The grabber fingers 166 are pivotally coupled to the main body 164 such that the grabber fingers 166 are each rotatable about a vertical axis. A pair of actuators (e.g., hydraulic motors, electric motors, etc.), shown as finger actuators 168, are configured to control movement of the grabber fingers 166 relative to the main body 164.

The grabber assembly 162 is movably coupled to a guide, shown as track 170, that extends vertically along a side of the refuse vehicle 100. Specifically, the main body 164 is slidably coupled to the track 170 such that the main body 164 is repositionable along a length of the track 170. An actuator (e.g., a hydraulic motor, an electric motor, etc.), shown as lift actuator 172, is configured to control movement of the grabber assembly 162 along the length of the track 170. In some embodiments, a bottom end portion of the track 170 is straight and substantially vertical such that the grabber assembly 162 raises or lowers a refuse container when moving along the bottom end portion of the track 170. In some embodiments, a top end portion of the track 170 is curved such that the grabber assembly 162 inverts a refuse container to dump refuse into the hopper volume 132 when moving along the top end portion of the track 170.

The lift assembly 160 further includes an actuator (e.g., a hydraulic cylinder, an electric linear actuator, etc.), shown as track actuator 174, that is configured to control lateral movement of the grabber assembly 162. By way of example, the track actuator 174 may be coupled to the chassis 20 and the track 170 such that the track actuator 174 moves the track 170 and the grabber assembly 162 laterally relative to the chassis 20. The track actuator 174 may facilitate repositioning the grabber assembly 162 to pick up and replace refuse containers that are spaced laterally outward from the refuse vehicle 100.

### Refuse Vehicle With Hopper Panel and Pack Panel

In general, the refuse vehicles 100 illustrated in FIGS. 3-8 can be equipped with (i) a packing input (e.g., the operator controls 250, a button, a switch, a joystick, a soft key on a display, etc.) that is configured to automatically initiate a packing procedure where refuse is packed (e.g., moved, compacted, etc.) from the hopper volume 132 into the storage volume 134 and (ii) an ejection input (e.g., the operator controls 250, a button, a switch, a joystick, a soft key on a display, etc.) that is configured to automatically initiate an ejection procedure where refuse is ejected from the refuse compartment 130. The packing procedure gradually moves a hopper panel (which may also be referred to as a crusher panel and/or an assist panel) toward the hopper volume 132 (e.g., to help press refuse material into a working area of the pack panel) and gradually extends a pack panel toward an extended position. In some embodiments, activation of the packing input automatically moves the hopper panel and extends the pack panel. That is, in some embodiments, the positions of the hopper panel and the pack panel moved to during the packing procedure are predefined and activation of the packing input removes the need for a user of the refuse vehicle 100 to manually control the movement of the hopper panel and the pack panel during the packing procedure.

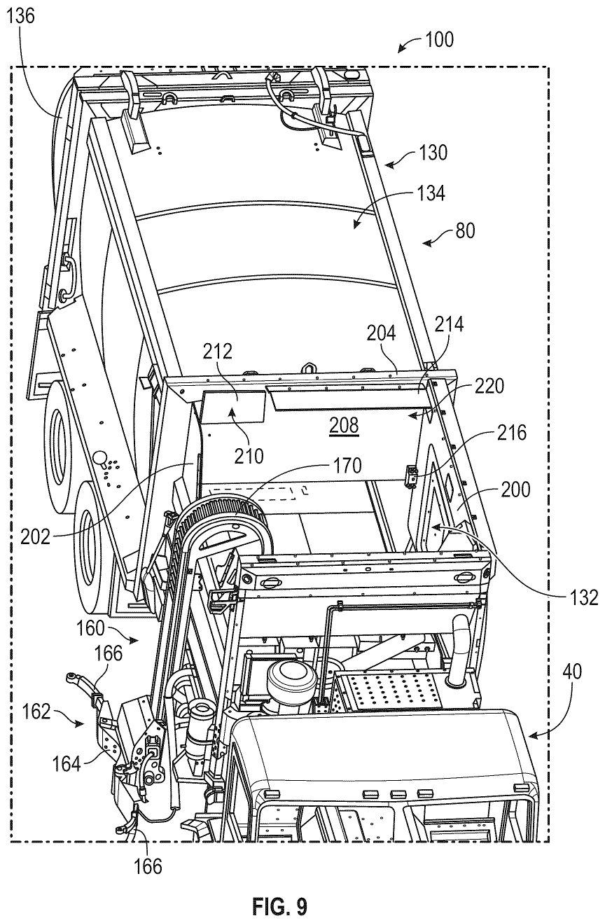

FIGS. 9-13 illustrate an exemplary embodiment of the refuse compartment 130 of the side-loading refuse vehicle 100. As shown in FIGS. 9-13, the hopper volume 132 is an internal volume of the refuse compartment 130 and is defined by a left sidewall 200, a right sidewall 202, a mid-wall, shown as holding plate 204, and a packing assembly 206. The left sidewall 200 extends longitudinally (e.g., in a direction extending between the cab 40 and the tailgate 136) between the holding plate 204 and the packing assembly 206. The lift assembly 160 is arranged on the right sidewall 202, and the holding plate 204 extends downwardly (e.g., in a direction toward the chassis 20, or in a direction perpendicular to the ground on which the refuse vehicle 100 travels) from a top wall of the refuse compartment 130. In general, the holding plate 204 separates at least a portion of the hopper volume 132 from at least a portion of the storage volume 134 and forms a partition between the two sections in the refuse compartment 130. In addition, the holding plate 204 aids in preventing refuse being packed into the storage volume 134 from falling back toward the hopper volume 132.

As shown in FIGS. 9, 10, 12, and 13, the refuse vehicle 100 includes a top wall (e.g., top panel, pack assist panel, crusher panel, etc.), shown as hopper panel 208. The hopper panel 208 is configured to pivotably couple to the holding plate 204 such that the hopper panel 208 can move (e.g., pivot, rotate, etc.) relative to the holding plate 204. The hopper panel 208 is configured to engage with refuse in the hopper volume 132 to pack (e.g., compress, compact, etc.) the refuse. The hopper panel 208 may be manufactured from a material capable of withstanding abrasions, scrapes, and impacts (e.g., against refuse being packed thereby) during repeated movement and repositioning of the hopper panel 208 (e.g., during the packing procedure). In some embodiments, the hopper panel 208 is sized (e.g., dimensioned) based on the size of the hopper volume 132. In some embodiments, the hopper panel 208 defines one or more other characteristics (e.g., thickness, material, weight, etc.) based on the type of refuse to be received in the hopper volume 132.

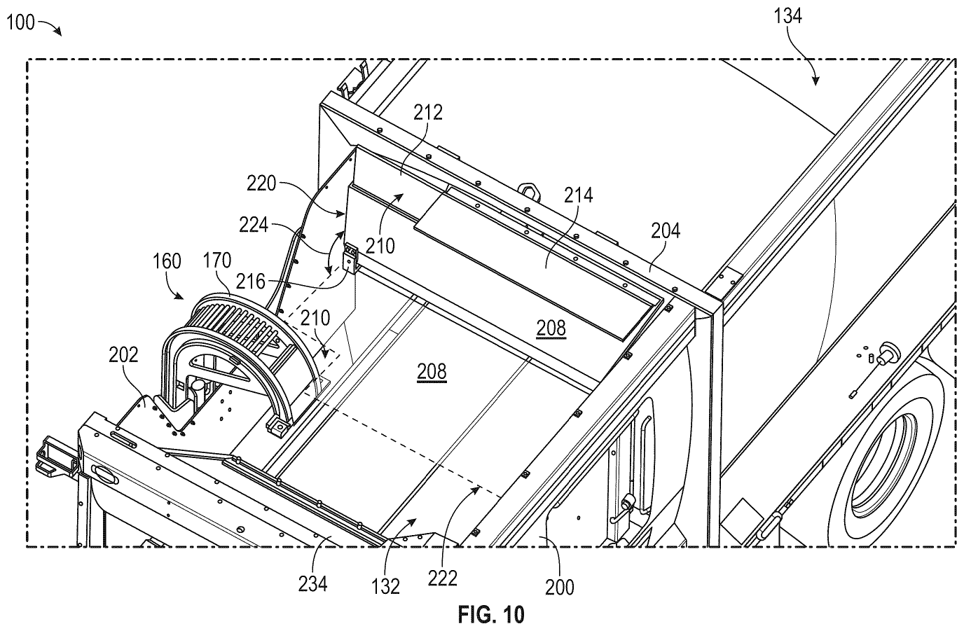

As shown in FIGS. 9 and 10, the hopper panel 208 defines an opening (e.g., space, aperture, etc.), shown as cutout 210. The cutout 210 may be sized, shaped, and positioned to receive at least a portion of the lift assembly 160 (e.g., when the hopper panel 208 is in an extended/packing position, as discussed in greater detail below) to permit movement of the hopper panel 208 relative to (e.g., past) the lift assembly 160. By way of example, the cutout 210 may be generally rectangularly shaped, arcuately shaped, or otherwise suitably shaped and sized to receive the lift assembly 160 such that the hopper panel 208 does not contact the lift assembly 160 during the packing procedure. By way of another example, the cutout 210 may be positioned corresponding to the location of the lift assembly 160. In such an example, the cutout 210 may be positioned at a right side (e.g., top right corner) of the hopper panel 208 when the lift assembly 160 is located at a right side of the refuse vehicle 100 such that the cutout 210 can receive the lift assembly 160 and permit movement of the hopper panel 208 relative to the lift assembly 160 during the packing procedure. In some embodiments, the hopper panel 208 does not include the cutout 210. By way of example, the hopper panel 208 may be sized or the lift assembly 160 may be positioned such that the lift assembly 160 does not interfere with the movement of the hopper panel 208 during the packing procedure. By way of another example, in a front-loading configuration, the refuse vehicle 100 may omit the lift assembly 160 and instead include the lift assembly 140. In such an example, the lift assembly 140 may not include any components that would interfere with the hopper panel 208 during the packing procedure.

As shown in FIGS. 9 and 10, the refuse vehicle 100 includes a first member (e.g., interfacing member, engagement member, fin, etc.), shown as hopper panel flap 212, configured to couple to the hopper panel 208. The hopper panel flap 212 is positioned to cover the cutout 210 and thereby prevent refuse material from escaping the hopper volume 132 through the cutout 210. In some embodiments, the hopper panel flap 212 is movable relative to the hopper panel 208. By way of example, when the lift assembly 160 is received by the cutout 210, the hopper panel flap 212 may contact the lift assembly 160 and move relative to the hopper panel 208 as the hopper panel 208 moves relative to the lift assembly 160 (e.g., the hopper panel flap 212 is angled relative to the hopper panel flap 212). By way of another example, when the hopper panel 208 is positioned at an upright position (or any other position where the hopper panel flap 212 is not engaged with the lift assembly 160), the hopper panel flap 212 may extend in a plane substantially parallel with the hopper panel 208. In some embodiments, the hopper panel flap 212 is manufactured from a material capable of withstanding abrasions, scrapes, and impacts against refuse and the lift assembly 160 during repeated movement and repositioning of the hopper panel 208 (e.g., during the packing procedure). In some embodiments, the refuse vehicle 100 does not include the hopper panel flap 212.

As shown in FIGS. 9 and 10, the refuse vehicle 100 includes a second member (e.g., interfacing member, engagement member, fin, etc.), shown as hopper panel extension 214, configured to couple to the hopper panel 208. The hopper panel extension 214 is positioned along a top edge of the hopper panel 208. The hopper panel extension 214 extends in a lateral direction along the hopper panel 208 and perpendicular to the hopper panel 208. In some embodiments, the hopper panel extension 214 moves relative to the hopper panel 208 during the packing procedure (e.g., as the hopper panel 208 packs the refuse in the hopper volume 132). In some embodiments, the hopper panel extension 214 is configured to extend a packing coverage (e.g., increase an area of the hopper panel 208 capable of packing refuse) of the hopper panel 208 to thereby prevent refuse material from escaping from the hopper volume 132). In some embodiments, the hopper panel extension 214 is integrally formed with the hopper panel 208. In some embodiments, the hopper panel extension 214 is manufactured from a material capable of withstanding abrasions, scrapes, and impacts against refuse during repeated movement and repositioning of the hopper panel 208 (e.g., during the packing procedure). In some embodiments, the refuse vehicle 100 does not include the hopper panel extension 214.

As shown in FIGS. 9-13, the hopper panel 208 is pivotably coupled to the holding plate 204 using pivot mounts (e.g., brackets, couplers, etc.), shown as pillow blocks 216. In some embodiments, the pillow blocks 216 are coupled to the holding plate 204 (e.g., a first pillow block 216 coupled to a left side of the holding plate 204 proximate the left sidewall 200 and a second pillow block 216 coupled to a right side of the holding plate 204 proximate the right sidewall 202). In other embodiments, the pillow blocks 216 are coupled to the left sidewall 200 and the right sidewall 202 (e.g., a first pillow block 216 coupled to the left sidewall 200 and a second pillow block 216 coupled to the right sidewall 202). In some embodiments, the pillow blocks 216 include bearings configured to receive a portion of the hopper panel 208 to facilitate rotation of the hopper panel 208 relative to the holding plate 204. By way of example, the hopper panel 208 may include protrusions configured to be received by the pillow blocks 216. By way of another example, the hopper panel 208 may be coupled to a shaft received within the pillow blocks 216 and configured to rotate with the shaft about an axis of rotation defined thereby. In some embodiments, the hopper panel 208 is otherwise pivotable, movable, etc. relative to the holding plate 204.

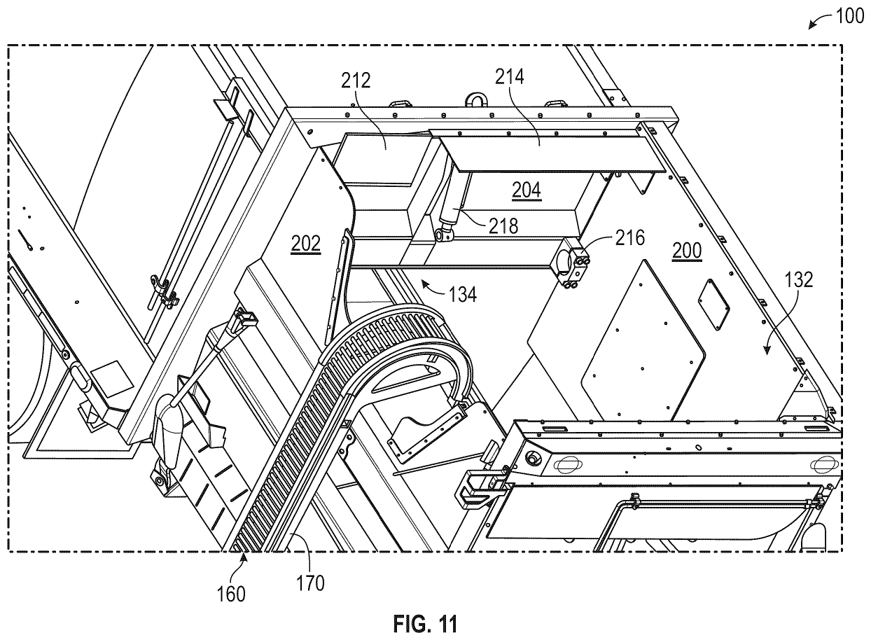

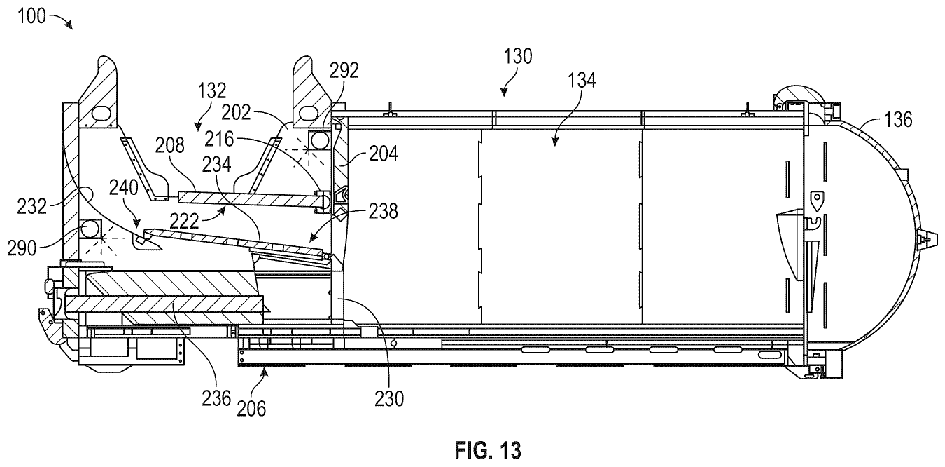

Referring to FIG. 11, the refuse compartment 130 is shown with the hopper panel 208 removed. As shown in FIG. 11, the refuse vehicle 100 includes a hopper panel actuator 218 coupled between the hopper panel 208 and the holding plate 204 and configured to selectively move the hopper panel 208 between an upright (e.g., retracted, filling, open, etc.) position, shown as first position 220 (see, e.g., FIGS. 9, 10, and 12), a closed (e.g., packing, extended, etc.) position, shown as second position 222 (see, e.g., FIGS. 10 and 13), and any position in between the first position 220 and the second position 222. In some embodiments, the hopper panel actuator 218 is a telescoping actuator that is pneumatically, hydraulically, electronically, or electro-hydraulically driven. In the first position 220, the hopper panel 208 is arranged generally vertically (e.g., in a direction perpendicular to a road on which the refuse vehicle 100 travels) and faces in a direction towards the front side 86 of the refuse vehicle 100. In the first position 220, the hopper panel 208 is arranged to not interfere (e.g., avoid contacting) with the operations of the lift assembly 140 or the lift assembly 160 (e.g., while loading refuse into the hopper volume 132). In the second position 222, the hopper panel 208 is arranged generally horizontally (e.g., in a direction substantially parallel with the road on which the refuse vehicle 100 travels). In the second position 222, the hopper panel 208 is positioned to inhibit refuse in the hopper volume 132 or the storage volume 134 from falling out of (e.g., leaving, being blown out of, etc.) the refuse compartment 130 (e.g., during transit). By way of example, in the second position 222, the hopper panel 208 may provide a barrier (e.g., cover, block, etc.) between the hopper volume 132 and the exterior environment to inhibit refuse from falling out of (e.g., leaving, being blown out of, etc.) the refuse compartment 130.

As shown in FIG. 10, an angle 224 is defined between the hopper panel 208 in the first position 220 and the hopper panel 208 in the second position 222. In some embodiments, the angle 224 is about 85 degrees (e.g., 81 degrees, 83 degrees, 87 degrees, 89 degrees, etc.). In other embodiments, the angle 224 is greater or less than 85 degrees (e.g., 60 degrees, 70 degrees, 90 degrees, 95 degrees, etc.). In some embodiments, the angle 224 is determined (e.g., the hopper panel 208 is moved to a position) based on the position of the follower plate 234 (as discussed in greater detail below). By way of example, the hopper panel 208 may be configured to move to a position to avoid contacting the follower plate 234 during the packing procedure. In some embodiments, the angle 224 is determined (e.g., the hopper panel 208 is moved to a position) based on a location or amount of refuse in the hopper volume 132. By way of example, the hopper panel 208 may be configured to move to a position to compact and displace refuse in the hopper volume 132 during the packing procedure. In such an example, when the hopper volume 132 is supporting a relatively larger volume of refuse therein (e.g., and the height of the refuse is relatively higher), the angle 224 may be less (e.g., such that the hopper panel 208 does not move as far from the first position 220) than when the hopper volume 132 is supporting a relatively smaller volume of refuse therein (e.g., and the height of the refuse is relatively lower).

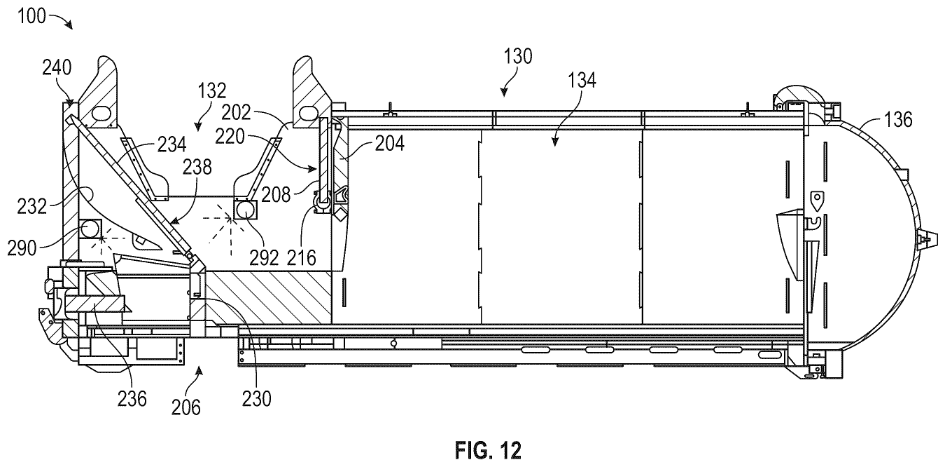

As shown in FIGS. 12 and 13, the packing assembly 206 includes a pack panel 230, a ramped or curved wall 232, a pivot or follower plate 234, and a pack panel actuator 236. The pack panel 230 (which may also be referred to as a blade and/or a packer) is arranged generally vertically (e.g., in a direction perpendicular to a road on which the refuse vehicle 100 travels) and faces in a direction toward the storage volume 134 (e.g., a normal extending from the outer surface of the pack panel 230 is directed toward the storage volume 134). A first end 238 of the follower plate 234 is rotatably coupled to a distal end of the pack panel 230 so that the follower plate 234 rotates relative to the pack panel 230 as the pack panel 230 moves between retracted and extended positions. A second end 240 of the follower plate 234 is configured to engage and slide along the curved wall 232 (e.g., when the pack panel 230 is in a position where the second end 240 of the follower plate 234 overlaps with the curved wall 232). The curved wall 232 defines a generally curved profile that ramps downwardly in a direction toward the storage volume 134.

As shown in FIGS. 12-14, the packing assembly 206 further includes a first sensor 290 (e.g., a camera, infrared sensor, ultraviolet sensor, a proximity sensor, a scale, or other refuse sensor) and a second sensor 292. The first sensor 290 is configured to detect refuse that falls behind the pivot or follower plate and/or the ramped or curved wall 232 and into the pack panel actuator 236. The second sensor 292 is configured to detect when refuse disposed in the packing assembly 206 reaches a particular threshold value for a dimensional characteristic (e.g., height, volume, weight, density, material composition, or another characteristic). The first sensor 290 and the second sensor 292 are in electronic communication with a processing circuit configured to execute at least one machine vision algorithm and/or program to detect and interpret the dimensional characteristics of the refuse disposed within the packing assembly 206. The first sensor 290 can be disposed on a sidewall of the refuse vehicle 100, such as the left sidewall 200 or the right sidewall 202, or can be disposed on another component of the refuse vehicle 100. In some embodiments, and as shown, the first sensor 290 is disposed proximally to the pack panel actuator 236 to detect refuse disposed within the pack panel actuator 236 (e.g., disposed in an area of the hopper volume 132 that is behind the follower plate 234 and the pack panel 230). The second sensor 292 can be disposed on a sidewall of the refuse vehicle 100, such as the left sidewall 200 or the right sidewall 202, or can be disposed on another component of the refuse vehicle 100. The second sensor 292 is disposed proximally to the hopper volume 132 (e.g., on an opposite side of the follower plate 234 as the first sensor 290) to detect refuse disposed within the refuse vehicle 100.

As shown in FIGS. 12 and 13, the pack panel 230 is coupled to the pack panel actuator 236 so that the pack panel actuator 236 selectively moves the pack panel 230 between a retracted or home position (see, e.g., FIG. 12) and an extended or eject position (see, e.g., FIG. 13), between the extended position and the retracted position, and any position in between the extended position and the retracted position. In some embodiments, the pack panel actuator 236 is a telescoping actuator that is pneumatically, hydraulically, electronically, or electro-hydraulically driven.

According to an exemplary embodiment, a packing procedure generally includes (i) moving the hopper panel 208 from the first position 220 to the second position 222 (or another position where the hopper panel 208 is at least partially pivoted relative to the first position 220) and (ii) moving the pack panel 230 from the retracted position to a position where the pack panel 230 is at least partially extended from the retracted position in a direction toward the extended position. During the packing procedure, the hopper panel 208 pivots towards the hopper volume 132 from the first position 220 to compact and displace refuse in the hopper volume 132 in at least one of (i) a direction vertically downward in the hopper volume 132 (e.g., farther into the hopper volume 132) or (ii) a direction toward the storage volume 134. Similarly, in the retracted position, the pack panel 230 is arranged at least partially within the hopper volume 132, and the packing procedure extends the pack panel 230 toward the storage volume 134 to compact and displace refuse in the hopper volume 132 in a direction toward the storage volume 134. Moving the hopper panel 208 and the pack panel 230 to compact and displace the refuse enables the hopper volume 132 to be repeatedly filled and packed until the storage volume 134 is full and an ejection procedure is to be initiated. In some embodiments, after the packing procedure, the hopper panel 208 remains in the second position 222 to inhibit refuse from falling out of the refuse compartment 130 via the hopper volume 132. An ejection procedure may be initiated after the packing procedure, and may generally include moving the pack panel 230, via the pack panel actuator 236, to the extended or eject position to eject refuse from the storage volume 134 when the tailgate 136 is open.

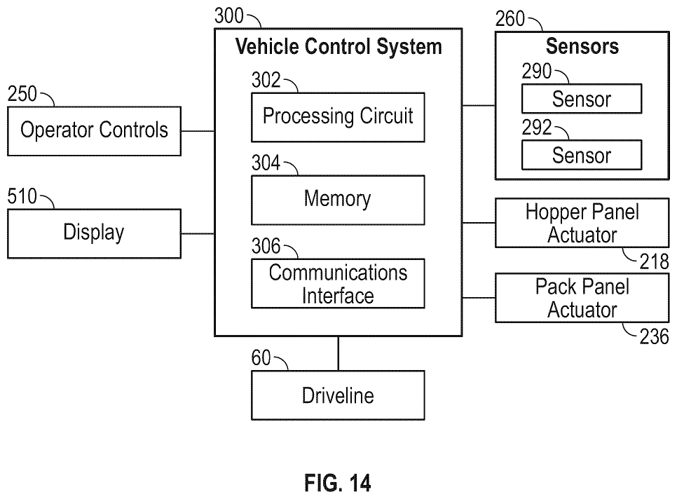

As shown in FIG. 14, the refuse vehicle 100 includes operator input and output devices, shown as operator controls 250, positioned about the refuse vehicle 100 (e.g., within the cab interior 42, along an exterior of the cab 40, along an exterior of the application kit 80, etc.). According to an exemplary embodiment, the operator controls 250 are configured to provide an operator with the ability to control one or more functions of and/or provide commands to the refuse vehicle 100 and the components thereof (e.g., turn on, turn off, drive, turn, brake, engage various operating modes, raise/lower an implement, etc.). The operator controls 250 may include one or more displays and one or more input devices. The one or more displays may be or include a touchscreen, an LCD display, a LED display, a speedometer, gauges, warning lights, etc. The one or more input devices may be or include buttons, switches, knobs, levers, dials, etc. In some embodiments, the operator controls 250 include one or more external devices remote from the refuse vehicle 100 to control operation thereof. By way of example, the operator controls 250 may include a computer, laptop, smartphone, tablet, or the like.

As shown in FIG. 14, the refuse vehicle 100 includes a display 510. The display 510 is configured to display one or more statuses and/or characteristics of the refuse vehicle, including a refuse capacity, a refuse density, a refuse volume, a refuse height, an actuation status of the pack panel 230, an actuation status of the hopper panel 208, or another status and/or characteristic. The display 510 may be configured to display a warning, message, and/or icon when refuse falls behind the curved wall 232 and/or follower plate 234 and into the pack panel actuator 236. In some embodiments, the display 510 includes a touchscreen, an LCD display, an LED display, a speedometer, gauges, warning light, icon, hologram, or projection disposed in the cab interior 42 of the refuse vehicle 100 and can further include a touch screen interface.

According to an exemplary embodiment, the processing circuit 302 is configured to automatically operate various components of the refuse vehicle 100, including the pack panel actuator 236 and the hopper panel actuator 218, in response to input from the first sensor 290 and/or the second sensor 292, via the vehicle control system 300. For example, the second sensor 292, in combination with the vehicle control system 300 and/or the processing circuit 302, can detect that refuse disposed within the hopper volume 132 is at a threshold height (e.g., 3 feet or another height). The second sensor 292 is configured to communicate a sensor input to the processing circuit 302. The processing circuit 302 may be configured to (i) initiate a pack cycle, (ii) control the hopper panel in coordination with the pack panel, and/or (iii) generate a notification (e.g., indication) responsive to the refuse satisfying (e.g., exceeding, being greater than or equal to, etc.) the threshold height.

In some embodiments, the processing circuit 302 is configured to execute one or more machine vision programs (e.g., software configured to enable processing circuits to interpret and/or characterize visual inputs) to analyze the sensor data. The machine vision program(s), when executed, determine (e.g., extract) a height and volume characteristic of the refuse disposed within the refuse vehicle 100. When the height characteristic satisfies a threshold value (e.g., is greater than or equal to 3 feet or another threshold height), the vehicle control system 300 automatically sends a signal to the hopper panel actuator 218 with instructions to actuate, compacting refuse disposed within the refuse vehicle 100 with the hopper panel 208. The refuse vehicle 100 may then continue loading material into the hopper volume 132. In other embodiments, the vehicle control system 300 may also be configured to initiate a pack cycle to move contents of the hopper volume 132 into the storage volume responsive to the height characteristic satisfying a threshold value.

In some embodiments, when the volume characteristic reaches a threshold value (e.g., 30 cubic yards), the vehicle control system 300 automatically sends a signal to the pack panel actuator 236 with instructions to actuate, compacting refuse disposed within the refuse vehicle 100 with the pack panel 230. In some embodiments, actuating the pack panel actuator 236 and/or the hopper panel actuator 218 in response to input from the first sensor 290 and/or the second sensor 292 without any separate inputs from the operator controls 250. Such an arrangement can reduce driver distraction and increase efficiency by reducing unnecessary actuation of the pack panel actuator 236 and/or the hopper panel actuator 218. In some embodiments, the vehicle control system 300 is configured to generate a notification responsive to the height characteristic exceeding a threshold value to inform the operator of the hopper condition, and to solicit input from the operator about whether to initiate a pack cycle and/or to actuate the hopper panel 208. It is noted that any of the packing procedures described or illustrated in the present specification and/or figures may be automatically initiated in response to inputs from the first sensor 290, the second sensor 292, the vehicle control system 300, and/or the processing circuit 302.

By way of another example, in some embodiments, the processing circuit 302 and/or the vehicle control system 300 are configured to automatically retract the pack panel actuator 236 before extending the pack panel 230 (e.g., at the outset of the pack cycle) when the first sensor 290 and/or the second sensor 292, in combination with the vehicle control system 300 and/or the processing circuit 302, detect that the volume or height of refuse disposed within the refuse vehicle 100 rises above a threshold value, and/or responsive to a determination that refuse material has encroached into the space behind the pack panel 230. Retracting the pack panel actuator 236 in this manner can help capture refuse material that bridges across the opening of the hopper volume 132 above the pack panel 230, and can thereby prevent refuse disposed within the refuse vehicle 100 from falling behind the follower plate 234 and/or the curved wall 232 and onto the pack panel actuator 236.

By way of another example, refuse deposited within the refuse vehicle 100 (e.g., inadvertently during a lift cycle, due to abnormal packing operation, etc.) can fall behind the follower plate 234 and/or the curved wall 232 and into the pack panel actuator 236. The first sensor 290, in combination with the vehicle control system 300 and/or the processing circuit 302, is configured to detect when refuse falls into the pack panel actuator 236. The first sensor 290 is configured to communicate a sensor input (e.g., sensor data) to the processing circuit 302. The processing circuit 302 is configured to execute one or more machine vision programs to analyze the sensor input. The machine vision program(s), when executed, determine whether refuse is disposed within the pack panel actuator 236. In other embodiments, (e.g., such as where the first sensor 290 includes a proximity sensor that simply detects material adjacent to or near the first sensor 290 in the area of the pack actuator), the processing circuit 302 may be configured to determine the presence of refuse material behind the pack panel 230 and/or the follower plate 234 without using a machine vision and/or learning algorithm.

In some embodiments, if refuse is disposed within the pack panel actuator 236, the processing circuit 302 and/or the vehicle control system 300 are configured to send a signal to the pack panel actuator 236 instructing it to slow movement of the pack panel 230, stop movement of the pack panel 230, and/or reverse a movement direction of the pack panel 230, until the processing circuit 302 receives an indication (e.g., sensor input) that indicates that the refuse material has been removed or cleared. In some embodiments, the processing circuit 302 is configured to send a signal to the display 510, and the display 510 is configured to display a warning indicating that refuse must be cleared from the pack panel actuator 236 before the hopper panel actuator 218 and/or the pack panel actuator 236 can be operated. In some embodiments, the vehicle control system 300 is configured to prevent actuation of the pack panel actuator 236 until the machine vision program or other detection technique determines, by a sensor input from the first sensor 290, that refuse has been removed from the area of the pack panel actuator 236.

In some embodiments, the first sensor 290 also includes a camera or other image sensor. The processing circuit 302 may be configured to capture images of the area of the pack panel actuator 236 responsive to detection of refuse material within the area of the pack panel actuator 236. The processing circuit 302 may also be configured to transmit and/or combine date/time information (e.g., a timestamp) with the image data, which can be later used to provide confirmation of the incident to a fleet manager, or other customer.

By way of another example, an item of refuse (e.g., a large cardboard box or another elongate item) disposed within a compartment (e.g., the hopper volume 132) of the refuse vehicle 100 may bridge across the compartment (e.g., span the entire width of the compartment) when the pack panel 230 and/or the hopper panel 208 is compressing refuse disposed within the compartment, inhibiting motion of the pack panel 230 and/or the hopper panel 208. The first sensor 290 and/or the second sensor 292, in combination with the vehicle control system 300 and/or the processing circuit 302, are configured to detect when the item bridges above the pack panel 230 and/or the follower plate 234 (e.g., bridges a hopper opening above the pack panel 230). The first sensor 290 and/or the second sensor 292 are configured to communicate a sensor input to the processing circuit 302. The processing circuit 302 is configured to execute one or more machine vision programs or other material detection techniques to analyze the sensor input. The machine vision program(s), when executed, determine if the item of refuse is bridging the compartment of the refuse vehicle 100. In some embodiments, the machine vision program is trained to predict whether bridging will occur based on a set of operating conditions and/or conditions within the hopper volume 132 (e.g., based on sensor inputs from the first sensor 290 and/or the second sensor 292, and/or other route information such as type of refuse material being collected, weight of refuse materials, patterns in pack height changes, etc.). If the machine vision program(s) determine that the item of refuse is bridging the compartment of the refuse vehicle 100, then the vehicle control system 300 and/or the processing circuit 302 send a signal to the pack panel actuator 236 and/or the hopper panel actuator 218, instructing the actuators to retract in order to clear the bridge, then resume the compaction process.

In some embodiments, the first sensor 290 and/or the second sensor 292, in combination with the vehicle control system 300 and/or the processing circuit 302, are configured to detect a material composition (e.g., paper, plastic, glass, aluminum, steel, or other material) and/or waste category (e.g., cans, bottles, boxes, or other waste category) of refuse disposed within the refuse vehicle 100. The first sensor 290 and/or the second sensor 292 are configured to communicate a sensor input to the processing circuit 302. The processing circuit 302 is configured to execute one or more machine vision programs to analyze the sensor input. The machine vision program(s), when executed, determine the material composition and/or waste category of refuse disposed within the refuse vehicle 100. In some embodiments, the processing circuit 302 is configured to vary intervals between actuating the pack panel actuator 236 and/or the hopper panel actuator 218 depending on the material composition and/or waste category of refuse disposed within the refuse vehicle 100. For example, the processing circuit 302 may actuate the pack panel actuator 236 and/or the hopper panel actuator 218 less frequently for denser materials (e.g., glass bottles or dishware) and more frequently for less dense materials (e.g., cardboard boxes or paper), or vice versa.

As shown in FIG. 14, the refuse vehicle 100 includes a plurality of sensors, shown as sensors 260, positioned about the refuse vehicle 100 to acquire vehicle information or vehicle data regarding operation of the refuse vehicle 100. By way of example, the sensors 260 may include an accelerometer, a gyroscope, a compass, a position sensor (e.g., a GPS sensor, etc.), an inertial measurement unit (“IMU”), a force sensor, suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the refuse vehicle 100. In some embodiments, one or more of the sensors 260 are configured to facilitate detecting and obtaining data regarding the operation of the hopper panel actuator 218 and the pack panel actuator 236 to determine a position of thereof (e.g., to determine the angle 224 at which the hopper panel 208 is positioned relative to the first position 220, to determine an extension distance of the pack panel 230 relative to the retracted position, etc.). In some embodiments, one or more of the sensors 260 are configured to monitor the refuse in the refuse compartment 130. By way of example, the sensors 260 may acquire data indicative of a weight of the refuse stored in the refuse compartment 130 (e.g., in the hopper volume 132 and/or the storage volume 134), data indicative of a type of refuse (e.g., garbage, recycling, etc.) being loaded in the hopper volume 132, among other information. The sensors 260 include the first sensor 290 and the second sensor 292.

As shown in FIG. 14, the refuse vehicle 100 includes a control system, shown as vehicle control system 300. The vehicle control system 300 may be coupled to the driveline 60, the hopper panel actuator 218, the pack panel actuator 236, the operator controls 250, the sensors 260, among other components of the refuse vehicle 100 (e.g., the tailgate actuator 138, the lift assembly 140, the lift assembly 160, etc.). The vehicle control system 300 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 14, the vehicle control system 300 includes a processing circuit 302, a memory 304, and a communications interface 306. The processing circuit 302 may include an ASIC, one or more FPGAs, a DSP, circuits containing one or more processing components, circuitry for supporting a microprocessor, a group of processing components, or other suitable electronic processing components. In some embodiments, the processing circuit 302 is configured to execute computer code stored in the memory 304 to facilitate the activities described herein. The memory 304 may be any volatile or non-volatile or non-transitory computer-readable storage medium capable of storing data or computer code relating to the activities described herein. According to an exemplary embodiment, the memory 304 includes computer code modules (e.g., executable code, object code, source code, script code, machine code, etc.) configured for execution by the processing circuit 302. In some embodiments, the vehicle control system 300 may represent a collection of processing devices. In such cases, the processing circuit 302 represents the collective processors of the devices, and the memory 304 represents the collective storage devices of the devices.

In one embodiment, the vehicle control system 300 is configured to selectively engage, selectively disengage, control, or otherwise communicate with components of the refuse vehicle 100 (e.g., via the communications interface 306, a controller area network (“CAN”) bus, etc.). According to an exemplary embodiment, the vehicle control system 300 is coupled to (e.g., communicably coupled to) components of the driveline 60 (e.g., the batteries 62, the drive motors 64, etc.), the hopper panel actuator 218, the pack panel actuator 236, the operator controls 250, the sensors 260, among other components of the refuse vehicle 100 (e.g., the tailgate actuator 138, the lift assembly 140, the lift assembly 160, the display 510, etc.). By way of example, the vehicle control system 300 may send and receive signals (e.g., control signals, location signals, etc.) with the components of the driveline 60, the hopper panel actuator 218, the pack panel actuator 236, the operator controls 250, the sensors 260, and/or remote systems or devices (via the communications interface 306 as described in greater detail herein).

According to an exemplary embodiment, the operator controls 250 are in communication with the vehicle control system 300 such that the vehicle control system 300 automatically instructs the hopper panel actuator 218 and/or the pack panel actuator 236 to initiate the packing procedure in response to a user input to the operator controls 250. In some embodiments, after the user input to the operator controls 250 to initiate the packing procedure, the vehicle control system 300 initially verifies that the tailgate 136 is in the closed position. If the sensors 260 (e.g., a tailgate sensor) indicate that the tailgate 136 is in the open position, an indication (e.g., a light, a sound, and/or a message displayed on a display) is provided to a user of the refuse vehicle 100 that instructs the user to close the tailgate 136. If the sensors 260 indicate that the tailgate 136 is in the closed position, the vehicle control system 300 instructs the hopper panel actuator 218 and/or the pack panel actuator 236 to perform the packing procedure.

In general, during the packing procedure, (i) the hopper panel actuator 218 is configured to move the hopper panel 208 to any position along the angle 224 between the first position 220 and the second position 222 and (ii) the pack panel actuator 236 is configured to move the pack panel 230 to any position along a length between the retracted position and the extended position. The packing procedure may include any number of steps or positions (e.g., moved positions, angled positions, extended positions, retracted positions, etc.) for the hopper panel 208 and the pack panel 230. In some embodiments, during the packing procedure, the hopper panel 208 and the pack panel 230 are moved to a plurality of positions (e.g., through the plurality of steps in the packing procedure). In some embodiments, each of the plurality of positions is sequentially closer to the second position 222 for the hopper panel 208 and the retracted position for the pack panel 230. In some embodiments, at least two of the plurality of positions are at the same moved position for the hopper panel 208 and at the same extension distance for the pack panel 230. In some embodiments, the hopper panel 208 is moved back to the first position 220 and the pack panel 230 is retracted back to the retracted position after reaching each of the positions, which maintains refuse below the hopper panel 208 and in front of the pack panel 230. In some embodiments, the hopper panel 208 is moved back to a previous moved position after each subsequent movement, and the pack panel 230 is retracted back to a previous extended position after each subsequent extension. After the packing procedure, the hopper panel 208 may remain in the second position 222 (or another suitable position between the first position 220 and the second position 222) to inhibit refuse from falling out of the refuse compartment 130 via the hopper volume 132. Further, to contain the collected refuse material, the hopper panel 208 may be closed in the second position 222 (or another suitable position between the first position 220 and the second position 222) at all times when the refuse vehicle 100 is traveling. In some examples, the hopper panel 208 is controlled to be closed whenever the transmission is in gear (e.g., a clutch of the refuse vehicle 100 is engaged to move the refuse vehicle 100 forward or in reverse). The hopper panel 208 can be further configured to automatically open to the first position 220 whenever a refuse collection operation is initiated (e.g., in response to movement of the lift assembly 140 or the lift assembly 160).

Regardless of the specific number and location of the plurality of positions to which the hopper panel 208 and the pack panel 230 are moved to, in some embodiments, the number and location of the plurality of positions moved to during the packing procedure are predefined and stored in the memory 304. The vehicle control system 300 is configured to instruct the hopper panel actuator 218 and the pack panel actuator 236 to synchronously (e.g., cooperatively, coordinately, etc.) execute the predefined packing procedure stored in the memory 304. By way of example, in response to the user input to the operator controls 250 (e.g., a single user input), the vehicle control system 300 may control the hopper panel actuator 218 and the pack panel actuator 236 to synchronously move (e.g., move at the same time, move to the one or more predefined positions, etc.) the hopper panel 208 and the pack panel 230, respectively. In this way, for example, the packing procedure is automatically controlled and initiated by activation of the packing input via the operator controls 250, which removes the need for a user of the refuse vehicle 100 to manually control the packing procedure (e.g., manually control the hopper panel actuator 218 and the pack panel actuator 236 independent of each other). Further, automatically initiating the packing procedure can enable better (e.g., more accurate, efficient, etc.) control of the positions of the hopper panel 208 and the pack panel 230 to help prevent or inhibit refuse from unintentionally leaving the refuse compartment 130 and falling behind the pack panel 230, to help prevent or inhibit damage to the packing assembly 206, the hopper panel 208, the hopper panel actuator 218, etc. Further, automatically initiating the packing procedure can reduce a number of packing cycles needed to pack the refuse into the storage volume 134. It should be appreciated that although the properties and functionality of the packing procedure are described with reference to the side-loading configuration of the refuse vehicle 100, the packing assembly 206, the hopper panel 208, the hopper panel actuator 218, etc. are also capable of being incorporated into the front-loading configuration of the refuse vehicle 100 to control the packing procedure in the same or similar manner.

According to an exemplary embodiment, the vehicle control system 300 is configured to activate a pack cycle or movement of the pack panel and/or hopper panel responsive to sensor inputs that indicate that a height and/or volume of refuse material within the hopper volume 132 satisfies (e.g., is greater than or equal to, exceeds, etc.) a threshold value. Such operations customize vehicle operation based on route characteristics and can prevent unnecessary activation of the pack cycle between stops along a route (e.g., a retirement community in Arizona might only need to be packed every six stops/homes as compared to a neighborhood in Wichita, Kansas, which might require a pack cycle for every two stops/homes). The vehicle control system 300 will scan, via the first sensor 290 and/or the second sensor 292, the hopper volume 132 to determine a height of refuse material therein, and/or another parameter associated with the refuse material in the hopper volume 132 (e.g., a weight, a volume, etc.). The vehicle control system 300 will activate a pack cycle, and/or control operation of the hopper panel 208 and/or the pack panel 230, based on the height or other condition determination. If refuse material begins to bridge in the hopper volume 132 (e.g., due to packing a large cardboard box, etc.) the vehicle control system 300 may auto-retract the pack panel 230 and then repack to clear the hopper opening.

In some embodiments, and as described herein, the vehicle control system 300 is configured to coordinate operation of the hopper panel 208 with the pack panel 230 to further reduce the risk of material loss from the hopper volume 132, and to increase pack efficiency. Such arrangements can reduce operator distraction by automating the pack cycle, and reducing their reliance on the hopper monitor while driving. Such arrangements can also reduce fuel/energy consumption and provide increased power for the driver (as the number of total pack cycles along the route is reduced and material based).

The automated cycles of the present disclosure are particularly advantageous for compressed natural gas (CNG) operated refuse vehicle arrangements, and can help prevent CNG stalling. For example, in addition to packing based on hopper conditions, the vehicle control system 300 of the present disclosure may be configured to delay activation of the pack cycle until other operating parameters are satisfied, such as engine RPM (e.g., so that the refuse vehicle 100 does not initiate the packing procedure until a certain RPM is met to minimize stalling or sluggish performance).

According to an exemplary embodiment, the vehicle control system 300 is configured to control operation of the hopper panel actuator 218 and the pack panel actuator 236 in at least one of a first mode of operation or a second mode of operation based on a refuse characteristic associated with the refuse filled in the refuse compartment 130. By way of example, in the first mode of operation, the vehicle control system 300 may control the hopper panel actuator 218 and the pack panel actuator 236 to move the hopper panel 208 and the pack panel 230, respectively, according to a first sequence (e.g., pattern, frequency, etc.) of positions (e.g., including a first respective number and location of positions), compact the hopper panel 208 and the pack panel 230 at first respective compaction forces, etc. By way of another example, in the second mode of operation, the vehicle control system 300 may control the hopper panel actuator 218 and the pack panel actuator 236 to move the hopper panel 208 and the pack panel 230, respectively, according to a second sequence of positions (e.g., including a second respective number and location of positions) different than the first sequence of positions (e.g., the second number of positions being greater or less than the first number of positions, the second location of the hopper panel 208 and the pack panel 230 compacting the refuse more or less often or more or less dense than in the first location, etc.), compact the hopper panel 208 and the pack panel 230 at second respective compaction forces (e.g., the second compaction forces being greater or less than the first compaction forces), etc.

In some embodiments, the refuse characteristic includes a pack density of the refuse in the refuse compartment 130, a weight of the refuse in the refuse compartment 130, a volume of the refuse in the refuse compartment 130, a height of the refuse in the hopper volume 132, among other characteristics associated with the refuse in the refuse compartment 130 such that the vehicle control system 300 controls operation of the hopper panel actuator 218 and/or the pack panel actuator 236 based on the pack density, the weight, the volume, the height, etc., of the refuse. In some embodiments, the refuse characteristic is determined based on data acquired by one or more of the sensors 260. By way of example, the sensors 260 may include a force sensor configured to monitor the weight of the refuse in the hopper volume 132 and the storage volume 134. In such an example, the volume and/or density of the refuse in the refuse compartment 130 may be determined based on the weight of the refuse. By way of another example, the sensors 260 may include a camera configured to monitor the height of the refuse in the hopper volume 132. By way of still another example, the sensors 260 may include a pressure sensor coupled to the hopper panel actuator 218 and the pack panel actuator 236 configured to monitor the pressure the hopper panel 208 and the pack panel 230 apply to compact the refuse. In some embodiments, the refuse characteristic is determined based on a number of packing cycles performed in an amount of time (e.g., during one day, during one route, etc.).

When the refuse characteristic is less than a predetermined threshold, the vehicle control system 300 may control operation of the refuse vehicle 100 in the first mode of operation, and when the refuse characteristic exceeds the predetermined threshold, the vehicle control system 300 may control operation of the refuse vehicle 100 in the second mode of operation. By way of example, in response to a determination that the weight, volume, and/or density of the refuse in the hopper volume 132 and the storage volume 134 is less than a weight, volume, and/or density threshold (e.g., 50% of a maximum weight, volume, and/or density capacity, 75% of a maximum weight, volume, and/or density capacity, etc.), the vehicle control system 300 may control operation of the refuse vehicle 100 in the first mode of operation, and in response to a determination that the weight, volume, and/or density of the refuse in the hopper volume 132 and the storage volume 134 is greater than the weight, volume, and/or density threshold, the vehicle control system 300 may control operation of the refuse vehicle 100 in the second mode of operation. By way of another example, in response to a determination that the height of the refuse in the hopper volume 132 is less than a height threshold (e.g., below the hopper panel 208 in the second position 222, below a top wall defining the storage volume 134, etc.), the vehicle control system 300 may control operation of the refuse vehicle 100 in the first mode of operation, and in response to a determination that the height of the refuse in the hopper volume 132 is greater than the height threshold, the vehicle control system 300 may control operation of the refuse vehicle 100 in the second mode of operation. By way of still another example, in response to a determination that the pressure the hopper panel 208 and/or the pack panel 230 apply to compact the refuse is less than a pressure threshold (e.g., 50% of a maximum capacity of the hopper panel actuator 218 and/or the pack panel actuator 236, 75% of a maximum capacity of the hopper panel actuator 218 and/or the pack panel actuator 236, etc.), the vehicle control system 300 may control operation of the refuse vehicle 100 in the first mode of operation, and in response to a determination that the pressure is greater than the pressure threshold, the vehicle control system 300 may control operation of the refuse vehicle 100 in the second mode of operation. By way of still another example, in response to a determination that the number of packing cycles performed in the amount of time is less than a packing cycle threshold (e.g., 50 in one hour, 100 in one route, 100 in one day, etc.), the vehicle control system 300 may control operation of the refuse vehicle 100 in the first mode of operation, and in response to a determination that the number of packing cycles performed in the amount of time is greater than the packing cycle threshold, the vehicle control system 300 may control operation of the refuse vehicle 100 in the second mode of operation.

In some embodiments, the refuse characteristic includes a type of the refuse (e.g., recycling, garbage, etc.) loaded into the hopper volume 132 such that the vehicle control system 300 controls the hopper panel actuator 218 and/or the pack panel actuator 236 based on the type of refuse. In some embodiments, the user provides an input to the operator controls 250 (e.g., selects an icon on a graphical user interface displayed by the operator controls 250, pushes a button of the operator controls 250, etc.) indicative of the refuse type. In other embodiments, the type of refuse to be collected can be determined automatically based upon the day of refuse vehicle 100 operation (e.g., if there are designated recycling and garbage collection days). In some embodiments, the type of refuse to be collected can be input remotely (e.g., from a fleet command center or network computer in communication with the vehicle control system 300 of the refuse vehicle 100). In other embodiments, the type of refuse being collected can be determined based upon characteristics (e.g., size, color, shape, etc.) of the refuse container being accessed, determined by one or more of the sensors 260.

Selecting the “garbage” input or the “recycling” input (or another type of waste input, such as organic material) from the operator controls 250 adjusts the operation mode of the hopper panel actuator 218 and/or the pack panel actuator 236 to effectively deal with each different type of refuse properly. If the recycling input is selected, the vehicle control system 300 may control operation in the first mode of operation. Recycling materials are generally lightweight and loosely packed (or entirely unpacked) materials and are advantageously compacted frequently to improve the overall capacity of the refuse compartment 130, so the rate at which the hopper panel 208 and the pack panel 230 are moved can be increased in the first mode of operation. Similarly, because recycling materials may be light-weight (e.g., cardboard), the recycling materials are often prone to blowing out of the hopper volume 132. If the garbage input is selected, the vehicle control system 300 may control operation in the second mode of operation. Because the garbage materials may be generally heavier and denser, the hopper panel actuator 218 and the pack panel 230 may move the hopper panel 208 and the pack panel 230 using a greater pressure.

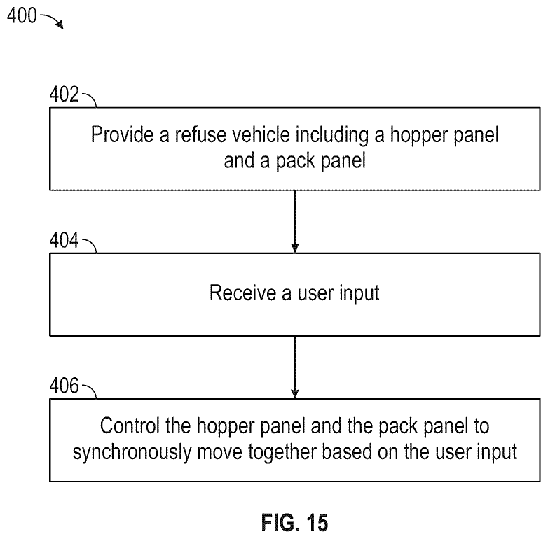

As shown in FIG. 15, a method of controlling a refuse vehicle (e.g., the refuse vehicle 100), shown as method 400, includes steps 402-406. In some embodiments, one or more steps of the method 400 are performed by the vehicle control system 300. In some embodiments, the method 400 is executed by any combination of one or more controllers or other suitable devices, such a separate controller communicably coupled with the processing circuit 302, or any other suitable system.

At step 402, the refuse vehicle is provided. The refuse vehicle includes a hopper panel (e.g., the hopper panel 208) and a pack panel (e.g., the pack panel 230). According to an exemplary embodiment, the refuse vehicle further includes a refuse compartment (e.g., the refuse compartment 130) defining a hopper volume (e.g., the hopper volume 132) and a storage volume (e.g., the storage volume 134), and a lift assembly (e.g., the lift assembly 140, the lift assembly 160) configured to engage with a refuse container and move the refuse container to load refuse therefrom into the hopper volume of the refuse compartment. The hopper panel is configured to be pivotably coupled with the refuse compartment between a first, upright position and a second, closed position. In the first position, the hopper panel is disposed to permit refuse being loaded into the hopper volume, and, in the second position, the hopper panel is disposed to inhibit refuse from being loaded or from leaving (e.g., unintentionally falling out of) the refuse compartment. The pack panel is configured to extend and retract to displace the refuse in the hopper volume in a direction towards the storage volume. The hopper panel and the pack panel are coupled with independent actuators and configured to move (e.g., pivot, rotate, extend, retract, etc.) based on extension and retraction of the actuators.

At step 404, a user input is received. In some embodiments, the user input is provided to operator controls such as a button, switch, knob, lever, dial, computer, laptop, smartphone, tablet, or the like. The user input may be indicative of a command to initiate a packing procedure where refuse is packed (e.g., moved, compacted, etc.) from the hopper volume into the storage volume.

At step 406, the hopper panel and the pack panel are configured to be controlled to synchronously move together based on the user input. In other words, in response to receiving the user input, a control system (e.g., the vehicle control system 300) is configured to initiate the packing procedure to (i) move the hopper panel toward the hopper volume and (ii) extend the pack panel toward an extended position. The positions of the hopper panel and the pack panel moved to during the packing procedure are predefined and activation of the packing input (e.g., in response to the user input) removes the need for a user of the refuse vehicle to manually control the movement of the hopper panel and the pack panel during the packing procedure. The control system is configured to instruct the hopper panel actuator and the pack panel actuator to synchronously (e.g., cooperatively, coordinately, etc.) execute the predefined packing procedure. By way of example, in response to the user input to the operator controls (e.g., a single user input), the control system may control the hopper panel actuator and the pack panel actuator to synchronously move (e.g., move at the same time, move to the one or more predefined positions, etc.) the hopper panel and the pack panel, respectively. In this way, for example, the packing procedure is automatically controlled and initiated by activation of the packing input via the operator controls, which removes the need for a user of the refuse vehicle to manually control the packing procedure (e.g., manually control the hopper panel actuator and the pack panel actuator independent of each other). Further, automatically initiating the packing procedure enables better (e.g., more accurate, efficient, etc.) control of the positions of the hopper panel and the pack panel to help prevent or inhibit refuse from unintentionally leaving the refuse compartment and falling behind the pack panel, to help prevent or inhibit damage to the packing assembly, the hopper panel, the hopper panel actuator, etc. Further, automatically initiating the packing procedure enables reducing a number of packing cycles needed to pack the refuse into the storage volume.

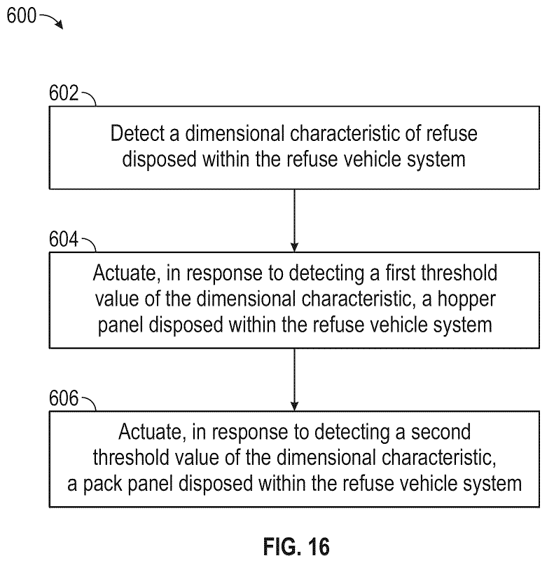

As shown in FIG. 16, a method of controlling a refuse vehicle (e.g., the refuse vehicle 100), shown as method 600, includes steps 602-606. In some embodiments, one or more steps of the method 600 are performed automatically by the processing circuit 302 and/or the vehicle control system 300. In some embodiments, the method 600 is executed by any combination of one or more processors or other suitable devices, or any other suitable system.

At step 602, a dimensional characteristic of refuse disposed within the refuse vehicle is detected. In some embodiments, a first sensor (e.g., the first sensor 290) and/or a second sensor (e.g., the second sensor 292), generate sensor data indicative of a height, weight, volume, and/or composition of refuse disposed within the refuse vehicle by sending an input to the vehicle control system and/or the processing circuit and processing the input by executing a machine vision program or other dimensional characteristic detection technique on the vehicle control system and/or the processing circuit.

At step 604, a hopper panel (e.g., the hopper panel 208) disposed within the refuse vehicle is actuated in response to detecting a first threshold value of the dimensional characteristic. In some embodiments, the hopper panel is actuated by a hopper panel actuator (e.g., the hopper panel actuator 218) when a height, weight, volume, and/or composition of refuse disposed within the refuse vehicle exceeds a predetermined threshold value (e.g., 3 feet, 30 cubic yards, 500 pounds, or at least 30% aluminum), as determined by the machine vision program executed on the vehicle control system and/or the processing circuit. Actuating the hopper panel compresses the refuse disposed within the refuse vehicle.

At step 606, a pack panel (e.g., the pack panel 230) disposed within the refuse vehicle is actuated in response to detecting a second threshold value of the dimensional characteristic. In some embodiments, the pack panel is actuated by a pack actuator (e.g., the pack panel actuator 236) when a height, weight, volume, and/or composition of refuse disposed within the refuse vehicle 100 exceeds a predetermined threshold value (e.g., 3 feet, 30 cubic yards, 500 pounds, or at least 30% aluminum), as determined by the machine vision program or another detection technique executed by the vehicle control system and/or the processing circuit. Actuating the pack panel compresses the refuse disposed within the refuse vehicle.

According to an exemplary embodiment, the control system is configured to control operation of the hopper panel actuator and the pack panel actuator in at least one of a first mode of operation or a second mode of operation based on a refuse characteristic (e.g., the dimensional characteristic) associated with the refuse filled in the refuse compartment. By way of example, in the first mode of operation, the control system may control the hopper panel actuator and the pack panel actuator to move the hopper panel and the pack panel, respectively, according to a first sequence (e.g., pattern, frequency, etc.) of positions (e.g., including a first respective number and location of positions), compact the hopper panel and the pack panel at first respective compaction forces, etc. By way of another example, in the second mode of operation, the control system may control the hopper panel actuator and the pack panel actuator to move the hopper panel and the pack panel, respectively, according to a second sequence of positions (e.g., including a second respective number and location of positions) different than the first sequence of positions (e.g., the second number of positions being greater or less than the first number of positions, the second location of the hopper panel and the pack panel compacting the refuse more or less often or more or less dense than in the first location, etc.), compact the hopper panel and the pack panel at second respective compaction forces (e.g., the second compaction forces being greater or less than the first compaction forces), etc. In some embodiments, the refuse characteristic includes a pack density of the refuse in the refuse compartment, a weight of the refuse in the refuse compartment, a volume of the refuse in the refuse compartment, a height of the refuse in the hopper volume, among other characteristics associated with the refuse in the refuse compartment such that the control system controls operation of the hopper panel actuator and/or the pack panel actuator based on the pack density, the weight, the volume, the height, etc., of the refuse. In other embodiments, the refuse characteristic includes a type of the refuse (e.g., recycling, garbage, etc.) loaded into the hopper volume such that the control system controls the hopper panel actuator and/or the pack panel actuator based on the type of refuse.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A refuse vehicle system comprising:
one or more processing circuits configured to:
receive an input signal; and
control, in response to receiving the input signal, a first actuator coupled with a hopper panel of a refuse vehicle, and a second actuator coupled with a pack panel to synchronously move the hopper panel and the pack panel according to a packing procedure,
wherein synchronous movement of the hopper panel and the pack panel facilitates compacting refuse in a refuse compartment of the refuse vehicle, and
wherein the one or more processing circuits are configured to control the first actuator and the second actuator in a first mode of operation or a second mode of operation based on a refuse characteristic associated with the refuse.

2. The refuse vehicle system of claim 1, wherein the refuse compartment includes a hopper volume and a storage volume, wherein the packing procedure includes moving the hopper panel from a first position toward a second position and moving the pack panel from a retracted position toward an extended position such that the refuse is displaced from the hopper volume into the storage volume.

3. The refuse vehicle system of claim 2, wherein the packing procedure includes a plurality of steps, each step including a corresponding position of the hopper panel and a corresponding position of the pack panel, and wherein the one or more processing circuits are configured to:
move the hopper panel and the pack panel through the plurality of steps; and
retract at least one of the hopper panel or the pack panel to a previous position after at least one step of the plurality of steps.

4. The refuse vehicle system of claim 2, wherein the one or more processing circuits are configured to:
control the first actuator to maintain the hopper panel in the second position during refuse vehicle travel; and
move the hopper panel from the second position to the first position in response to receiving the input signal.

5. The refuse vehicle system of claim 1, wherein the refuse characteristic includes at least one of a pack density, a weight, a volume, or a height of the refuse in the refuse compartment.

6. The refuse vehicle system of claim 1, wherein the refuse characteristic includes a type of the refuse in the refuse compartment.

7. The refuse vehicle system of claim 6, wherein the one or more processing circuits are configured to determine the type of the refuse based on at least one of:
an operator input;
a designated collection day; or
sensor data acquired by one or more sensors of the refuse vehicle.

8. The refuse vehicle system of claim 1, wherein the one or more processing circuits are configured to:
control operation of the first actuator and the second actuator in the first mode of operation when the refuse characteristic is less than a predetermined threshold; and
control operation of the first actuator and the second actuator in the second mode of operation when the refuse characteristic exceeds the predetermined threshold.

9. The refuse vehicle system of claim 8, wherein, in the first mode of operation, the one or more processing circuits are configured to control the first actuator and the second actuator according to a first sequence of positions and first compaction forces, and wherein, in the second mode of operation, the one or more processing circuits are configured to control the first actuator and the second actuator according to a second sequence of positions and second compaction forces, different from the first sequence of positions and the first compaction forces.

10. The refuse vehicle system of claim 1, further comprising one or more cameras configured to acquire sensor data regarding the refuse characteristic, wherein the refuse characteristic includes a height of the refuse within a hopper volume of the refuse compartment.

11. The refuse vehicle system of claim 1, wherein the input signal is generated based on at least one of an operator input or the refuse characteristic exceeding a predetermined threshold.

12. The refuse vehicle system of claim 1, wherein the one or more processing circuits are configured to delay initiation of the packing procedure until an operating parameter of a driveline of the refuse vehicle satisfies a predetermined condition.

13. The refuse vehicle system of claim 1, further comprising one or more sensors configured to monitor the refuse within the refuse compartment, wherein the one or more processing circuits are configured to:
determine, based on data from the one or more sensors, whether the refuse is present in an area behind the pack panel; and
in response to determining a presence of the refuse behind the pack panel, at least one of:
slow movement of the pack panel;
stop movement of the pack panel; or
reverse a movement direction of the pack panel.

14. The refuse vehicle system of claim 1, wherein the hopper panel is configured to be pivotably coupled to a holding plate of the refuse vehicle separating a hopper volume and a storage volume of the refuse compartment.

15. The refuse vehicle system of claim 1, wherein the hopper panel defines an opening configured to receive at least a portion of a lift assembly of the refuse vehicle to facilitate movement of the hopper panel past the lift assembly.

16. A refuse vehicle comprising:
a chassis;
a refuse compartment supported by the chassis and including a hopper volume and a storage volume;
a holding plate partially separating the hopper volume from the storage volume;
a packing assembly including:
a hopper panel pivotably coupled with the holding plate;
a first actuator coupled with the hopper panel;
a pack panel; and
a second actuator coupled with the pack panel;
one or more processing circuits configured to:
receive an input signal to initiate a packing procedure;
control, in response to receiving the input signal, the first actuator and the second actuator to synchronously move the hopper panel and the pack panel to compact refuse in the refuse compartment; and
control the first actuator and the second actuator in a first mode of operation or a second mode of operation based on a refuse characteristic associated with the refuse.

17. The refuse vehicle of claim 16, wherein the refuse characteristic includes at least one of a pack density, a weight, a volume, or a height of the refuse in the refuse compartment.

18. The refuse vehicle of claim 17, wherein the one or more processing circuits are configured to:
control operation of the first actuator and the second actuator in the first mode of operation when the refuse characteristic is less than a predetermined threshold; and
control operation of the first actuator and the second actuator in the second mode of operation when the refuse characteristic exceeds the predetermined threshold.

19. The refuse vehicle of claim 18, wherein, in the first mode of operation, the one or more processing circuits are configured to control the first actuator and the second actuator according to a first sequence of positions and first compaction forces, and wherein, in the second mode of operation, the one or more processing circuits are configured to control the first actuator and the second actuator according to a second sequence of positions and second compaction forces, different from the first sequence of positions and the first compaction forces.

20. A refuse vehicle system comprising:
a non-transitory computer-readable medium having instructions stored thereon that, when executed by one or more processors, cause the one or more processors to:
receive an input signal indicative of an initiation of a packing procedure for a refuse compartment of a refuse vehicle;
determine, based on sensor data, a refuse characteristic associated with the refuse disposed within the refuse compartment;
select a first mode of operation or a second mode of operation based on the refuse characteristic; and
control a first actuator coupled with a hopper panel of the refuse vehicle and a second actuator coupled with a pack panel of the refuse vehicle to synchronously move the hopper panel and the pack panel according to the packing procedure that includes a plurality of steps, each step including a corresponding position of the hopper panel and a corresponding position of the pack panel,
wherein synchronous movement of the hopper panel and the pack panel according to the packing procedure facilitates compacting the refuse within the refuse compartment, and
wherein the first mode of operation and the second mode of operation correspond to at least one of different sequences of the plurality of steps or different compaction forces applied by at least one of the hopper panel or the pack panel.
